(19) United States
(12) Patent Application Publication
(10) Pub. No.: US 2018/0166771 A1
(43) Pub. Date: Jun. 14, 2018

(54) DEVICE AND METHOD FOR RECEIVING RADIO SIGNAL

(71) Applicant: BS-MoVA Technology Co., Ltd., Zhubei (TW)

(72) Inventor: SHENG-MING DENG, Zhubei (TW)

(21) Appl. No.: 15/835,405

(22) Filed: Dec. 7, 2017

(30) Foreign Application Priority Data
Dec. 9, 2016 (CN) 201611128544.1
Dec. 9, 2016 (TW) 105140851

(51) Int. Cl. H01Q 1/24; H01Q 5/371; H04B 1/08; H04B 1/00; H01Q 1/32

(52) U.S. Cl. CPC H01Q 1/247; H01Q 5/371; H04B 1/10; H04B 1/0064; H01Q 1/32; H04B 1/082

(57) ABSTRACT

A receiving antenna device, system, method and related modules and units for vehicle are provided. The receiving antenna device includes a receiving antenna module and an in-vehicle module which is connected to the receiving antenna module via a single cable. The receiving antenna module includes at least one antenna, at least one low noise amplifier and at least one signal combination unit. The in-vehicle module includes at least one signal separation unit. Each one of the signal combination unit is configured to combine two radio signals in different bands to a mixed-band signal. Each of the signal separation unit is configured to extract at least two single-band signals, dual-band signals, multi-band signals or combination thereof from the mixed-band signal.

### CROSS REFERENCE TO RELATED APPLICATION

This application claims priority of Chinese Patent Application Serial No. 201611128544.1, filed on Dec. 9, 2016, and Taiwanese Patent Application Serial No. 105140851, filed on Dec. 9, 2016.

### FIELD OF THE DISCLOSURE

The present disclosure relates generally to a receiving antenna device, method and related modules and units for vehicle. More specifically, the present disclosure relates to a receiving antenna device that enables a vehicle to receive multiple radio signals.

### BACKGROUND OF THE DISCLOSURE

Traditionally, for a vehicle to receive a radio signal, an antenna corresponding to the radio signal must be installed to a roof of the vehicle, and a cable electrically connected between the antenna and an in-vehicle system is used to send the radio signal from the antenna to the in-vehicle system. If two or more radio signals are to be received, not only two or more corresponding antennas had to be installed on the roof, but also two or more cables had to be connected between the two or more antennas and the in-vehicle system.

For example, the vehicle must install a FM antenna, a GPS antenna, and a digital TV antenna in order to receive a FM signal, a GPS signal and a digital TV signal, and then use three cables to connect each of the FM antenna, the GPS antenna, and the digital TV antenna independently to the in-vehicle system. Therefore, the number of cable must increase with the number of antennas, such that increases the complexity of the cabling which causing potential cable cluttering, unsightliness, and increasing cost.

### BRIEF SUMMARY OF THE DISCLOSURE

In view of the foregoing, a general objective of the present disclosure is to provide a receiving antenna system, method and related modules and units for vehicle that only uses a signal cable between multiple antennas and the in-vehicle system.

It should be understood, however, that this summary may not contain all aspects and embodiments of the present disclosure, that this summary is not meant to be limiting or restrictive in any manner, and that the disclosure as disclosed herein will be understood by one of ordinary skill to encompass obvious improvements and modifications thereto.

An embodiment of the present invention provides a receiving antenna device for a vehicle. The receiving antenna device comprises an in-vehicle module and a receiving antenna module. The in-vehicle module is coupled to an in-vehicle system and comprises at least one signal separation unit. The receiving antenna module is coupled to the in-vehicle module via a single cable and comprises at least one antenna, at least one low noise amplifier (LNA) and at least one signal combination unit. The at least one signal combination unit is configured to combine at least two radio signals of different bands received by the antenna into a single mixed-band signal. The signal combination unit comprises at least two input terminals, one output terminal and at least two branch circuits. Each of the branch circuits is coupled between one of the two input terminals and the output terminal, and comprises at least one filter circuit configured to filter one of the at least two radio signals of different bands to extract a single-band signal. Two of the single-band signal extracted from the branch circuits of the signal combination unit are combined into the single mixed-band signal. The at least one signal separation unit is configured to split the single mixed-band signal into at least two of single-band signals, dual-band signals, multi-band signals or a combination thereof and transmit the split signals to the in-vehicle module. The signal separation unit comprises one of the input terminals, at least two of the output terminal and at least two of the branch circuits. Each of the branch circuits is coupled between the input terminal and one of the two output terminals, and comprises at least one filter circuit configured to filter the single mixed-band signal to extract one of the single-band signals, the dual-band signals or the multi-band signal.

Another embodiment of the present invention provides a method of receiving radio signals for a vehicle. The method comprises the steps of: receiving two or more radio signals of different bands from at least one antenna; matching an impedance for the two or more radio signals of different bands by matching circuits corresponding to the radio signals of different bands; filtering the two or more radio signals of different bands with the matched impedance by filter circuits corresponding to the radio signals of different bands to extract at least one of a single-band signal, a dual-band signal and a multi-band signal; combining at least two of the single-band signal, the dual-band signal and the multi-band signal into a single mixed-band signal by directing the signals to a connection point; transmitting the single mixed-band signal to an in-vehicle module via a single cable; filtering the single mixed-band signal through a filter circuit of the in-vehicle module to extract the at least one of the single-band signal, the dual-band signal and the multi-band signal; and matching an impedance for at least one of the extracted single-band signal, the extracted dual-band signal and the extracted multi-band signal by matching circuits of the in-vehicle module.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, wherein:

FIG. 1 schematically illustrates a first embodiment of a receiving antenna device in the present disclosure;

FIG. 2 schematically illustrates a second embodiment of the receiving antenna device in the present disclosure;

FIG. 3 schematically illustrates a third embodiment of the receiving antenna device in the present disclosure;

FIG. 4 schematically illustrates a fourth embodiment of the receiving antenna device in the present disclosure;

FIG. 5 schematically illustrates a fifth embodiment of the receiving antenna device in the present disclosure;

FIG. 6 schematically illustrates a sixth embodiment of the receiving antenna device in the present disclosure;

FIG. 7 schematically illustrates a seventh embodiment of the receiving antenna device in the present disclosure;

FIG. 8 schematically illustrates an eighth embodiment of the receiving antenna device in the present disclosure;

FIG. 9 schematically illustrates a ninth embodiment of the receiving antenna device in the present disclosure;

FIG. 10 schematically illustrates a tenth embodiment of the receiving antenna device in the present disclosure;

FIG. 11 schematically illustrates an eleventh embodiment of the receiving antenna device in the present disclosure;

FIG. 12 schematically illustrates a twelfth embodiment of the receiving antenna device in the present disclosure;

FIG. 13 schematically illustrates a first embodiment of a signal combination unit in the receiving antenna device in the present disclosure;

FIG. 14 schematically illustrates a second embodiment of the signal combination unit in the receiving antenna device in the present disclosure;

FIG. 15 schematically illustrates a third embodiment of the signal combination unit in the receiving antenna device in the present disclosure;

FIG. 16 schematically illustrates a fourth embodiment of the signal combination unit in the receiving antenna device in the present disclosure;

FIG. 17 schematically illustrates a first embodiment of a signal separation unit in the receiving antenna device in the present disclosure;

FIG. 18 schematically illustrates a second embodiment of the signal separation unit in the receiving antenna device in the present disclosure;

FIG. 19 schematically illustrates a third embodiment of the signal separation unit in the receiving antenna device in the present disclosure;

FIG. 20 schematically illustrates a fourth embodiment of the signal separation unit in the receiving antenna device in the present disclosure;

FIG. 21 is a circuit diagram of a first embodiment of a matching circuit used in the signal combination unit and the signal separation unit of the receiving antenna device in the present disclosure;

FIG. 22 is a circuit diagram of a second embodiment of the matching circuit used in the signal combination unit and the signal separation unit of the receiving antenna device in the present disclosure;

FIG. 23 is a circuit diagram of a third embodiment of the matching circuit used in the signal combination unit and the signal separation unit of the receiving antenna device in the present disclosure;

FIG. 24 is a circuit diagram of a fourth embodiment of the matching circuit used in the signal combination unit and the signal separation unit of the receiving antenna device in the present disclosure;

FIG. 25 is a circuit diagram of a fifth embodiment of the matching circuit used in the signal combination unit and the signal separation unit of the receiving antenna device in the present disclosure;

FIG. 26 is a circuit diagram of a sixth embodiment of the matching circuit used in the signal combination unit and the signal separation unit of the receiving antenna device in the present disclosure;

FIG. 27 is a circuit diagram of a seventh embodiment of the matching circuit used in the signal combination unit and the signal separation unit of the receiving antenna device in the present disclosure;

FIG. 28 is a circuit diagram of an eighth embodiment of the matching circuit used in the signal combination unit and the signal separation unit of the receiving antenna device in the present disclosure;

FIG. 29 is a circuit diagram of a ninth embodiment of the matching circuit used in the signal combination unit and the signal separation unit of the receiving antenna device in the present disclosure;

FIG. 30 is a circuit diagram of a tenth embodiment of the matching circuit used in the signal combination unit and the signal separation unit of the receiving antenna device in the present disclosure;

FIG. 31 is a circuit diagram of a first embodiment of a filter circuit used in the signal combination unit and the signal separation unit of the receiving antenna device in the present disclosure;

FIG. 32 is a circuit diagram of a second embodiment of the filter circuit used in the signal combination unit and the signal separation unit of the receiving antenna device in the present disclosure;

FIG. 33 is a circuit diagram of a third embodiment of the filter circuit used in the signal combination unit and the signal separation unit of the receiving antenna device in the present disclosure;

FIG. 34 is a circuit diagram of a fourth embodiment of the filter circuit used in the signal combination unit and the signal separation unit of the receiving antenna device in the present disclosure;

FIG. 35 is a circuit diagram of a fifth embodiment of the filter circuit used in the signal combination unit and the signal separation unit of the receiving antenna device in the present disclosure;

FIG. 36 is a circuit diagram of a sixth embodiment of the filter circuit used in the signal combination unit and the signal separation unit of the receiving antenna device in the present disclosure;

FIG. 37 is a circuit diagram of a seventh embodiment of the filter circuit used in the signal combination unit and the signal separation unit of the receiving antenna device in the present disclosure;

FIG. 38 is a flow chart of a first embodiment of a method of receiving multiple radio signals using the receiving antenna device in the present disclosure;

FIG. 39 is a flow chart of a second embodiment of the method of receiving multiple radio signals using the receiving antenna device in the present disclosure;

FIG. 40 is a flow chart of a third embodiment of the method of receiving multiple radio signals using the receiving antenna device in the present disclosure;

FIG. 41 is a flow chart of a fourth embodiment of the method of receiving multiple radio signals using the receiving antenna device in the present disclosure;

FIG. 42 is a flow chart of a fifth embodiment of the method of receiving multiple radio signals using the receiving antenna device in the present disclosure;

FIG. 43 is a flow chart of a sixth embodiment of the method of receiving multiple radio signals using the receiving antenna device in the present disclosure;

FIG. 44 is a flow chart of a seventh embodiment of the method of receiving multiple radio signals using the receiving antenna device in the present disclosure;

FIG. 45 is a flow chart of an eighth embodiment of the method of receiving multiple radio signals using the receiving antenna device in the present disclosure; and

FIG. 46 is a flow chart of a ninth embodiment of the method of receiving multiple radio signals using the receiving antenna device in the present disclosure.

In accordance with common practice, the various described features are not drawn to scale and are drawn to emphasize features relevant to the present disclosure. Like reference characters denote like elements throughout the figures and text.

### DETAILED DESCRIPTION OF THE DISCLOSURE

The present disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

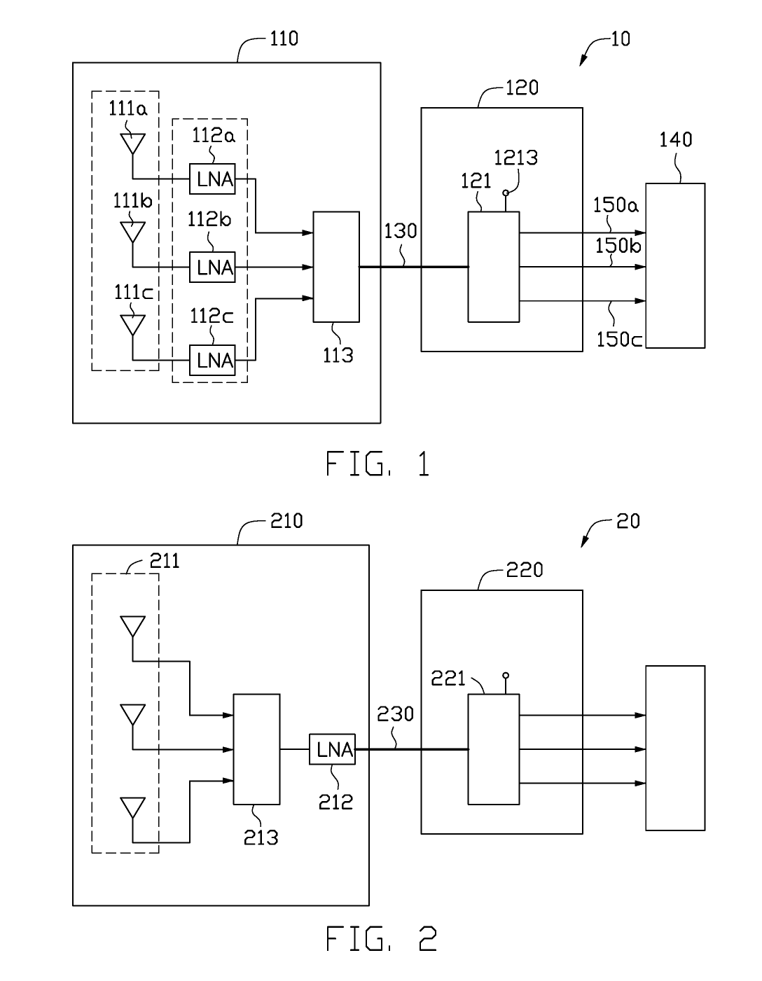

The description will be made as to the embodiments of the present disclosure in conjunction with the accompanying drawings in FIG. 1 to 46. Reference will be made to the drawing figures to describe the present disclosure in detail, wherein depicted elements are not necessarily shown to scale and wherein like or similar elements are designated by same or similar reference numeral through the several views and same or similar terminology.

Referring to FIG. 1 which schematically illustrates a first embodiment of a receiving antenna device in the present disclosure, the receiving antenna device 10 comprises a receiving antenna module 110, an in-vehicle module 120, and a single cable 130 connected between the receiving antenna module 110 and the in-vehicle module 120. The receiving antenna module 110 comprises multiple antennas, a signal combination unit 113 with multiple inputs and a single output, and multiple low-noise amplifiers (LNAs) connected between the multiple antennas and the signal combination unit 113 for signal amplification. The in-vehicle module 120 comprises a signal separation unit 121 with a single input and multiple outputs, such that a single cable 130 is connected between the single output of the signal combination unit 113 and the single input of the signal separation unit 121.

The multiple antennas receive multiple radio signals and convert them into multiple single-band signals to be sent to the multiple LNAs for signal amplification. Hence, the signal combination unit 113 receives the amplified single-band signals, wherein the signal combination unit 113 combines the multiple single-band signals into a mixed-band signal and sends the mixed-band signal to the in-vehicle module 120 via a single cable 130. Hence, the signal separation unit 121 of the in-vehicle module 120 receives the mixed-band signal, and the signal separation unit 121 splits the mixed-band signal into the multiple single-band signals, wherein the signal separation unit 121 sends the multiple single-band signals to an in-vehicle system 140.

In this embodiment, three different types of single-band antenna, which are a frequency modulation (FM) antenna 111a, a global positioning system (GPS) antenna 111b, and a digital television (digital TV) antenna 111c, are used as an example for illustration, and the types of antenna are not limited to the above. A LNA 112a is connected between the FM antenna 111a and the signal combination unit 113; a LNA 112b is connected between the GPS antenna 111b and the signal combination unit 113; a LNA 112c is connected between the digital TV antenna 111c and the signal combination unit 113. Hence, the LNA 112a amplifies a FM signal received by the FM antenna 111a and sends the amplified FM signal to the signal combination unit 113, and the LNA 112b amplifies a GPS signal received by the GPS antenna 111b and sends the amplified GPS signal to the signal combination unit 113, and the LNA 112c amplifies a digital TV signal received by the digital TV antenna 111c and sends the amplified digital TV signal to the signal combination unit 113. Thus, the signal combination unit 113 combines the amplified FM signal, the amplified GPS signal, and the amplified digital TV signal into a mixed-band signal and outputs the mixed-band signal to the signal separation unit 121 of the in-vehicle module 120 via the single output and the single cable 130.

The signal separation unit 121 splits the mixed-band signal to split signals, which are the FM signal, the GPS signal, and the digital TV signal. Then, the signal separation unit 121 outputs the FM signal, the GPS signal, and the digital TV signal to an in-vehicle system 140, wherein the in-vehicle system 140 comprises a FM player (not shown), a navigation device (not shown), and a digital TV display (not shown) corresponding to the FM antenna 111a, the GPS antenna 111b, and the digital TV antenna 111c, respectively. Therefore, the FM signal, the GPS signal, and the digital TV signal are sent from the signal separation unit 121 to the FM player, the navigation device, and the digital TV display, respectively.

The signal separation unit 121 further comprises a power input 1213 connected to the in-vehicle system 140 or any other external power source (not shown) for receiving power, and the power received is further provided to the LNA 112a, the LNA 112b, and the LNA 112c via the single cable 130 and the signal combination unit 113. Alternatively, the signal separation unit 121 receives power from the in-vehicle system 140, such that the power received is either provided by the FM player, the navigation device, or the digital TV display. However, the power is transmitted to the multiple LNAs via the single cable 130 and the signal combination unit 113 as well.

In one embodiment of the present disclosure, the multiple antennas can be micro strip antennas (as known as patch antenna), for example: micro strip antennas with ceramic substrate, planar single pole antenna, or stereoscopic single pole antenna, but not limited thereto. In this embodiment, the multiple antennas, the multiple LNAs and the signal combination unit 113 are arranged on a printed circuit board (PCB) (not shown) which is installed on a base (not shown), wherein the base and a casing form an antenna box (not shown) that can be installed to a roof or any other suitable places of a vehicle. In other embodiments, the multiple antennas, the multiple LNAs and the signal combination unit 113 can also be arranged separately on different PCBs that are disposed within the antenna box. The in-vehicle module 120 can be arranged on a PCB to be disposed in a box alone and connect to the in-vehicle system 140 by cables as shown in FIG. 1. In other embodiments, the in-vehicle module 120 can also be integrated into the in-vehicle system 140.

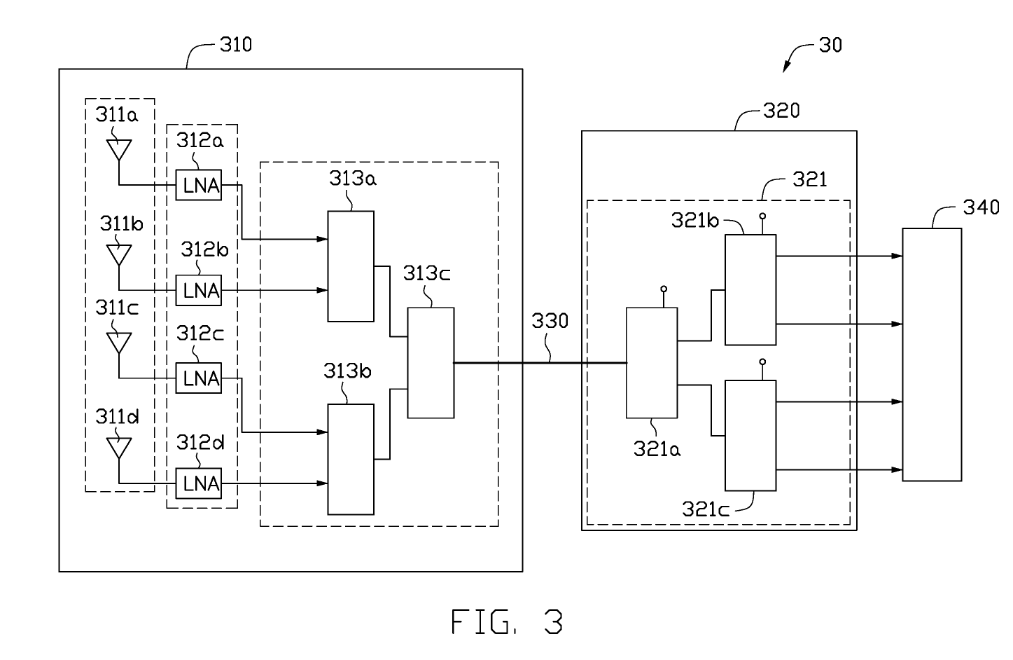

Referring to FIG. 2, which schematically illustrates a second embodiment of the receiving antenna device in the present disclosure, the receiving antenna device 20 comprises a receiving antenna module 210, an in-vehicle module 220, and a single cable 230 connected between the receiving antenna module 210 and the in-vehicle module 220. The receiving antenna module 210 comprises different types of single-band antennas 211, a LNA 212, and a signal combination unit 213. The LNA 212 is arranged between the signal combination unit 213 and the single cable 230 for amplifying a mixed-band signal from the signal combination unit 213, wherein the mixed-band signal is from combining multiple single-band signals, which are received by corresponding types of single-band antennas 211, by the signal combination unit 213. In other words, multiple single-band signals are amplified after being combined by the signal combination unit 213. The in-vehicle module 220 comprises a signal separation unit 221 for splitting the amplified mixed-band signal received from the LNA 212 into multiple single-band signals with different bands. Hence, the signal separation unit 221 sends the multiple single-band signals to the in-vehicle module 220. The in-vehicle module 220 receives power from the in-vehicle system or any other external power source to provide power to the LNA 212, therefore not further illustrated.

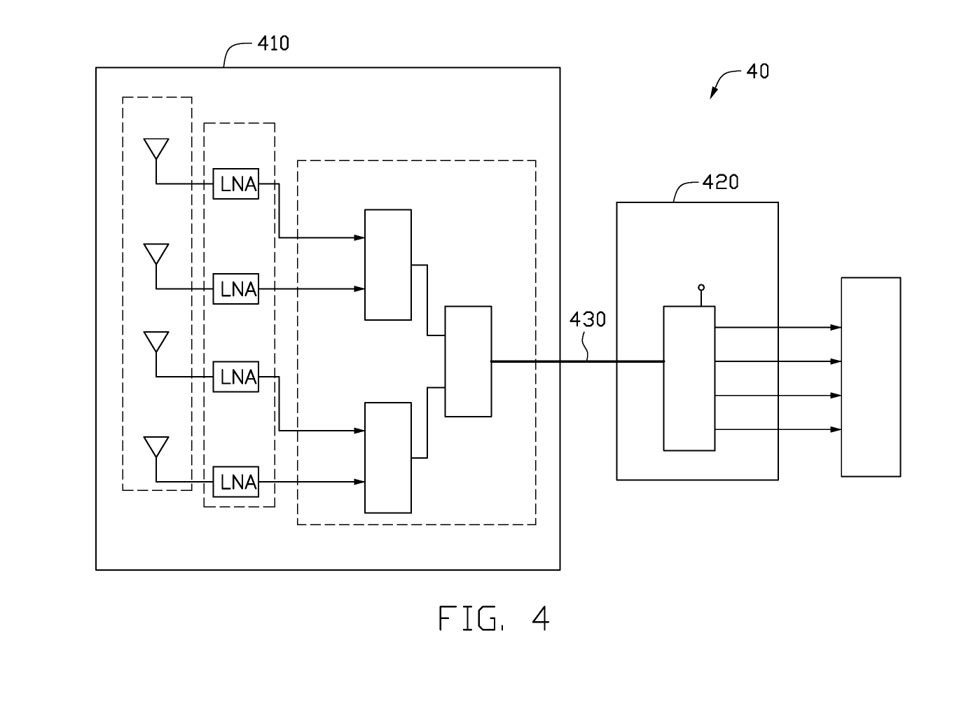

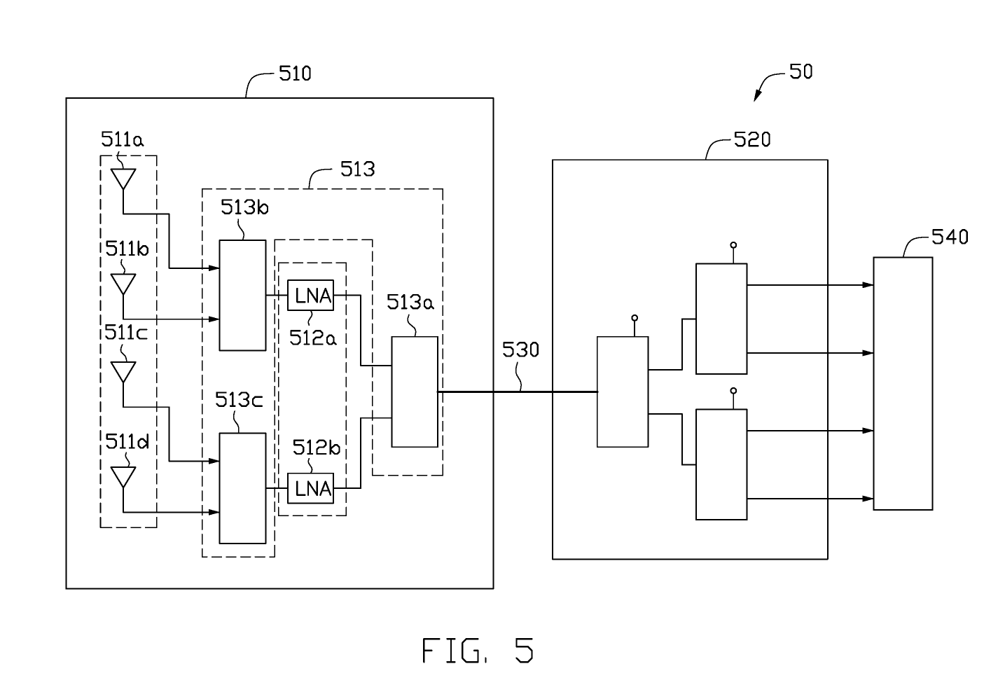

FIG. 3 schematically illustrates a third embodiment of the receiving antenna device in the present disclosure, the receiving antenna device 30 comprises a receiving antenna module 310, an in-vehicle module 320, and a signal cable 330 connected between the receiving antenna module 310 and the in-vehicle module 320. The receiving antenna module 310 comprises multiple single-band antennas, multiple LNAs, multiple signal combination units, wherein each of the multiple signal combination units comprises multiple inputs and a single output. The multiple LNAs are connected between the multiple single-band antennas and the multiple signal combination units, wherein each of the multiple LNAs corresponds to a single-band antenna for signal amplification. The in-vehicle module 320 comprises multiple signal separation units, wherein each of the multiple signal separation units comprises a single input and multiple outputs.

The multiple single-band antennas receive multiple radio signals and convert them into multiple single-band signals, followed by the multiple single-band signals being sent to the multiple LNAs for signal amplification. Hence, the multiple signal combination units receive the amplified single-band signals, wherein the multiple signal combination units combine the multiple single-band signals into multiple sub-mixed-band signals in first stage signal combination, and the multiple signal combination units further combine the multiple sub-mixed-band signals into a mixed-band signal in second stage signal combination, such that the multiple single-band signals are combined by the multiple signal combination units into a mixed-band signal in two stages of signal combination and sent to the in-vehicle module 320 via a signal cable 330. The multiple signal separation units of the in-vehicle module 320 receive the mixed-band signal, wherein the multiple signal separation units split the mixed-band signal into multiple sub-mixed-band signals in first stage signal separation unit, and the multiple signal separation units further split the multiple sub-mixed-band signals into multiple single-band signals, such that the mixed-band signal is split by the multiple signal separation units into multiple single-band signals in two stages of signal separation unit. Thus, the in-vehicle module 320 sends the multiple single-band signals to an in-vehicle system 340.

In this embodiment, two stages of signal combination with four different types of single-band antenna, which are a FM antenna 311a, a GPS antenna 311b, a digital TV antenna 311c, and a digital audio broadcasting (DAB) antenna 311d, are used as an example for illustration, and the types of antenna are not limited to the above.

A LNA 312a, a LNA 312b, a LNA 312c, and a LNA 312d are connected to the FM antenna 311a, the GPS antenna 311b, the digital TV antenna 311c, and the DAB antenna 311d for amplifying a FM signal, a GPS signal, a digital TV signal, and a DAB signal thereof, respectively. In first stage of signal combination, a first signal combination unit 313a receives the amplified FM signal and the amplified GPS signal and combines them into a first sub-mixed-band signal, which is sent to a signal combination unit 313; a second signal combination unit 313b receives the amplified digital TV signal and the amplified DAB signal and combines them into a second sub-mixed-band signal, which is sent to a third signal combination unit 313c for signal combination in second stage. Thus, in second stage of signal combination, the third signal combination unit 313c combines the first sub-mixed-band signal and the second sub-mixed-band signal into a mixed-band signal and sends it to the in-vehicle module 320 via the single cable 330.

In both stage of signal combination, though each of the first signal combination unit 313a, the second signal combination unit 313b, and the third signal combination unit 313c receives two signals of different types, it should be apparent to any person having ordinary skill that the number and types of signal to be received by any signal combination unit is not to be limited, such that the multiple signals can be single-band, dual-band, multi-band, or any combination thereof, as long as the multiple signals are in different bands from each other and in correspondence to the signal combination units.

For example, in one embodiment, the first signal combination unit 313a can receive two signals in different bands from two single-band antennas and combine them into a first sub-mixed-band signal, while the second signal combination unit 313b receives three signals in different bands from three single-band antennas and combines them into a second sub-mixed-band signal; in another embodiment, the first signal combination unit 313a can receive two signals in different bands from a dual-band antenna and combine them into a first sub-mixed-band signal, while the second signal combination unit 313b receives two signals in different bands from a single-band antenna and a dual-band antenna and combines them into a second sub-mixed-band signal.

Furthermore, though the above illustration only shows two stages of signal combination, wherein the first stage comprises the first signal combination unit 313a and the second signal combination unit 313b, and the second stage comprises the third signal combination unit 313c, it should be apparent to any person having ordinary skill that the receiving antenna device 30 can further comprise one or more signal combination units connected between multiple antennas and the single cable 330 when the receiving antenna device 30 needs to receive more radio signals with more antennas and/or multi band antennas, such that three or more stages of signal combination can be achieved.

For example, in one embodiment, the first stage can comprise four signal combination units, the second stage can comprise two signal combination units, and the third stage can comprise a signal combination unit. Thus, the first stage of signal combination outputs four sub-mixed-band signals for second stage of signal combination, wherein the second stage of signal combination outputs two sub-mixed-band signals for third stage of signal combination, and wherein the third stage of signal combination outputs a mixed-band signal to the in-vehicle module 320 via the single cable 330.

In this embodiment, two stages of signal separation unit is employed after the two stages of signal combination. The in-vehicle module 320 comprises a first signal separation unit 321a, a second signal separation unit 321b, and a third signal separation unit 321c. In first stage of signal separation unit, the first signal separation unit 321a receives the mixed-band signal from the third signal combination unit 313c and splits the mixed-band signal into a third sub-mixed-band signal and a fourth sub-mixed-band signal, that are sent to the second signal separation unit 321b and the third signal separation unit 321c respectively for second stage of signal separation unit, such that the second signal separation unit 321b splits the third sub-mixed-band signal and the third signal separation unit 321c splits the fourth sub-mixed-band signal in second stage of signal separation unit. Therefore, the third sub-mixed-band signal and the fourth sub-mixed-band signal are split into the FM signal, the GPS signal, the digital TV signal, and the DAB signal, that are sent to the in-vehicle system 340.

In both stage of signal separation unit, though each of the first signal separation unit 321a, the second signal separation unit 321b, and the third signal separation unit 321c outputs two single-band signals in different band, it should be apparent to any person having ordinary skill that the number and types of signal to be outputted by any signal separation unit is not to be limited, such that the outputted signals can be single-band, dual-band, multi-band, or any combination thereof as long as the outputted signals are in different bands from each other and in correspondence to the signal separation units.

Furthermore, though the above illustration only shows two stages of signal separation unit, wherein the first stage comprises the first signal separation unit 321a, and the second stage comprises the second signal separation unit 321b and the third signal separation unit 321c, it should be apparent to any person having ordinary skill that the receiving antenna device 30 can further comprise one or more signal separation units connected between the single cable 330 and the in-vehicle system 340 when the receiving antenna device 30 needs to receive more radio signals with more antennas and/or multi-band antennas, such that three or more stages of signal separation unit can be achieved.

Referring to FIG. 4, which schematically illustrates a fourth embodiment of the receiving antenna device in the present disclosure, the receiving antenna device 40 comprises a receiving antenna module 410, an in-vehicle module 420, and a single cable 430 connected between the receiving antenna module 410 and the in-vehicle module 420. The receiving antenna module 410 is similar to the receiving antenna module 310 in FIG. 3, and the in-vehicle module 420 is similar to the in-vehicle module 120. The in-vehicle module 420 comprises a signal separation unit to split a mixed-band signal into at least two signals with different bands from each other, wherein the signals can be single-band, dual-band, or multi band, and the in-vehicle module 420 can also receive power from an in-vehicle system or an external power source in order to provide power to multiple LNAs. Further details please refer to aforementioned embodiments.

Referring to FIG. 5, which schematically illustrates a fifth embodiment of the receiving antenna device in the present disclosure, the receiving antenna device 50 comprises a receiving antenna module 510, an in-vehicle module 520, and a single cable 530 connected between the receiving antenna module 510 and the in-vehicle module 520. The receiving antenna module 510 with two stages of signal combination comprises four antennas for different bands, three signal combination units, and two LNAs, wherein each of the three signal combination units has two inputs and a single output. More specifically, a first antenna 511a and a second antenna 511b are connected to two inputs of a second signal combination unit 513b, and a third antenna 511c and a fourth antenna 511d are connected to two inputs of a third signal combination unit 513c, wherein a LNA 512a and a LNA 512b are connected to the single output of the second signal combination unit 513b and the single output of the third signal combination unit 513c respectively, and wherein the LNA 512a and the LNA 512b are connected to two inputs of a first signal combination unit 513a, such that the LNA 512a is connected between the second signal combination unit 513b and the first signal combination unit 513a, and the LNA 512b is connected between the third signal combination unit 513c and the first signal combination unit 513a. Therefore, multiple signals received by the receiving antenna module 510 are combined by the second signal combination unit 513b and the third signal combination unit 513c before signal amplification by the LNA 512a and the LNA 512b. Thus, the first signal combination unit 513a combines two amplified mixed-band signals from the LNA 512a and the LNA 512b. The in-vehicle module 520 is similar to the in-vehicle module 320 in FIG. 3, such that the in-vehicle module 520 comprises three signal separation units that forms two stages of signal separation unit, wherein the first stage comprises a signal separation unit, while the second stage comprises two signal separation units, wherein a mixed-band signal sent from the receiving antenna module 510 via the single cable 530 is split into two mixed-band signals by the signal separation unit in first stage of signal separation unit, and the two mixed-band signals are further split by the two signal separation units in the second stage of signal separation unit. Therefore, the in-vehicle module 520 sends four signals, comprising a single-band signal, a dual-band signal and/or a multi-band signal, outputted by the second stage of signal separation unit to an in-vehicle system 540. In addition, the in-vehicle module 520 can also receive power from the in-vehicle system 540 or an external power source in order to provide power to the multiple LNAs.

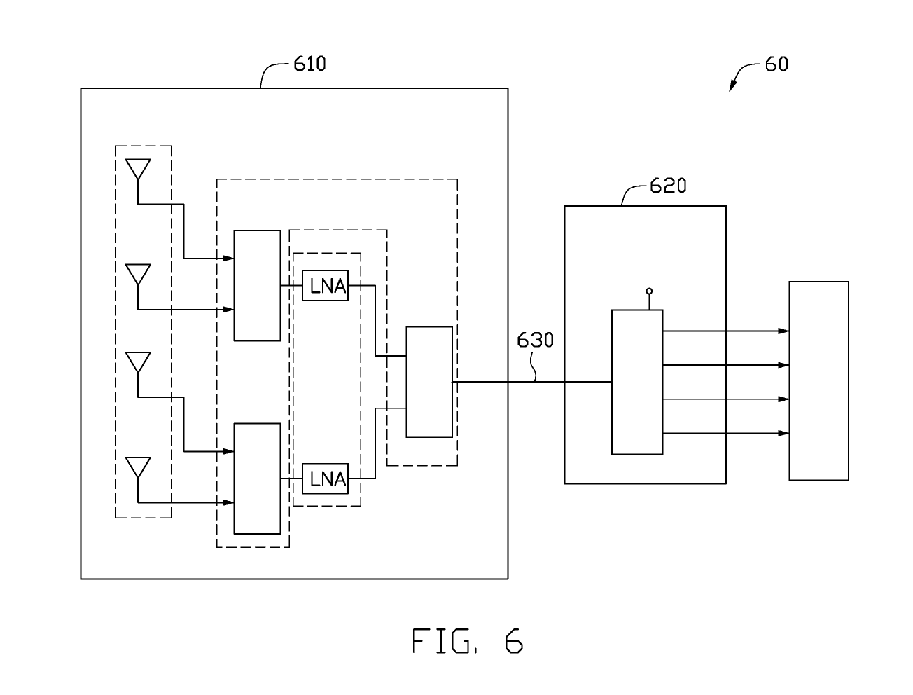

Referring to FIG. 6, which schematically illustrates a sixth embodiment of the receiving antenna device in the present disclosure, the receiving antenna device 60 comprises a receiving antenna module 610, an in-vehicle module 620, and a single cable 630 connected between the receiving antenna module 610 and the in-vehicle module 620. The receiving antenna module 610 is similar to the receiving antenna module 510 in FIG. 5. The in-vehicle module 620 is similar to the in-vehicle module 120 in FIG. 1, the in-vehicle module 220 in FIG. 2, and the in-vehicle module 420 in FIG. 4, such that the in-vehicle module 620 comprises a signal separation unit for splitting a mixed-band signal into at least two of single-band signals, dual-band signals and/or multi-band signals, and the in-vehicle module 620 can also receive power from an in-vehicle system or an external power source in order to provide power to multiple LNAs.

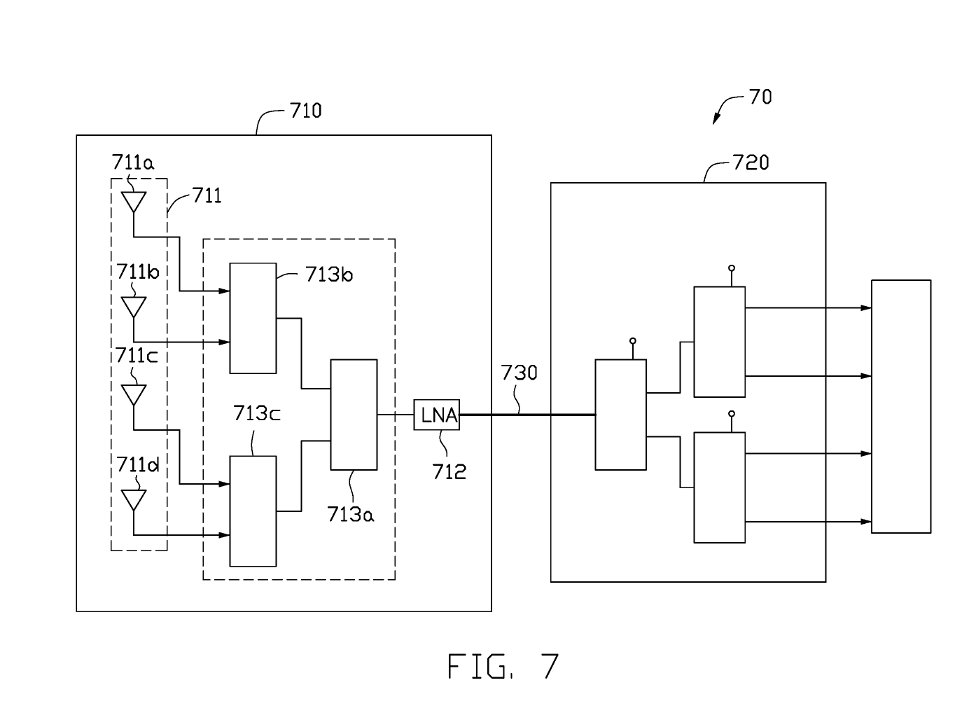

Referring to FIG. 7, which schematically illustrates a seventh embodiment of the receiving antenna device in the present disclosure, the receiving antenna device 70 comprises a receiving antenna module 710, an in-vehicle module 720, and a single cable 730 connected between the receiving antenna module 710 and the in-vehicle module 720. The receiving antenna module 710 with two stages of signal combination comprises four antennas for different bands, three signal combination units, and a LNA, wherein each of the three signal combination units has two inputs and a single output. More specifically, a first antenna 711a and a second antenna 711b are connected to two inputs of a second signal combination unit 713b, and a third antenna 711c and a fourth antenna 711d are connected to two inputs of a third signal combination unit 713c, wherein the single output of the second signal combination unit 713b and the single output of the third signal combination unit 713c are connected to the two inputs of a first signal combination unit 713a, and the LNA 712 is connected to the single output of the first signal combination unit 713a for amplifying a mixed-band signal therefrom. Therefore, multiple signals received by the receiving antenna module 710 are combined by the second signal combination unit 713b, the third signal combination unit 713c, and the first signal combination unit 713a into the mixed-band signal before signal amplification by the LNA 712. The in-vehicle module 720 is similar to the in-vehicle module 320 in FIG. 3 and the in-vehicle module 520 in FIG. 5, such that the in-vehicle module 720 comprises three signal separation units that forms two stages of signal separation unit, wherein the first stage comprises a signal separation unit, while the second stage comprises two signal separation units, wherein a mixed-band signal sent from the receiving antenna module 710 via the single cable 730 is split into two mixed-band signals by the signal separation unit in first stage of signal separation unit, and the two mixed-band signals are further split by the two signal separation units in the second stage of signal separation unit. Therefore, the in-vehicle module 720 sends four signals, comprising a single-band signal, a dual-band signal and/or a multi-band signal, outputted by the second stage of signal separation unit to an in-vehicle system 740. In addition, the in-vehicle module 720 can also receive power from the in-vehicle system 740 or an external power source in order to provide power to the multiple LNAs.

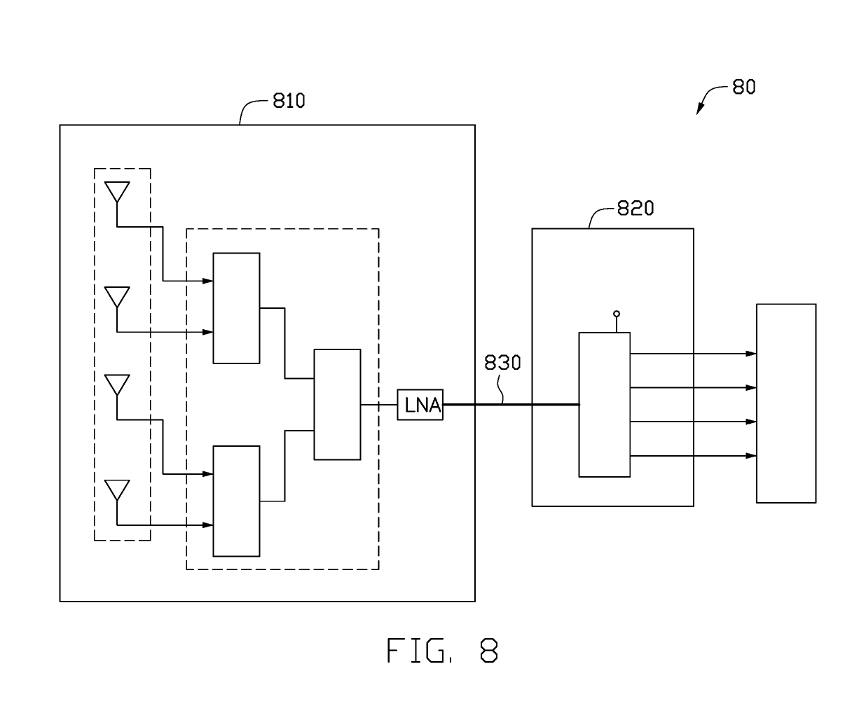

Referring to FIG. 8, which schematically illustrates an eighth embodiment of the receiving antenna device in the present disclosure, the receiving antenna device 80 comprises a receiving antenna module 810, an in-vehicle module 820, and a single cable 830 connected between the receiving antenna module 810 and the in-vehicle module 820. The receiving antenna module 810 is similar to the receiving antenna module 710 in FIG. 7. The in-vehicle module 820 is similar to the in-vehicle module 120 in FIG. 1, the in-vehicle module 220 in FIG. 2, the in-vehicle module 420 in FIG. 4, and the in-vehicle module 620 in FIG. 6, such that the in-vehicle module 820 comprises a signal separation unit for splitting a mixed-band signal into at least two of single-band signals, dual-band signal and/or multi-band signals, and the in-vehicle module 820 can also receive power from an in-vehicle system or an external power source in order to provide power to multiple LNAs.

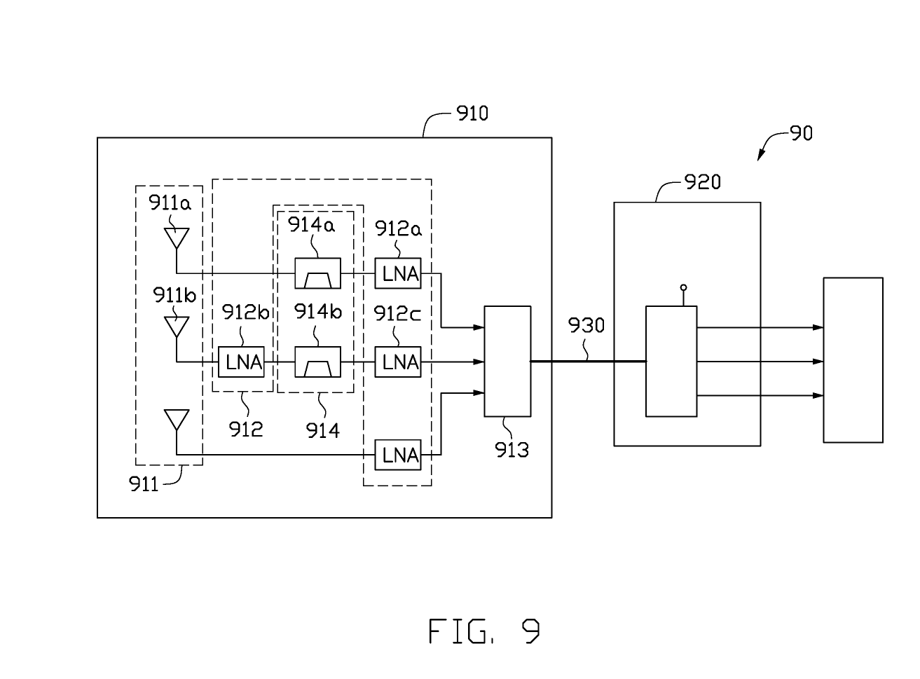

Referring to FIG. 9, which schematically illustrates a ninth embodiment of the receiving antenna device in the present disclosure, the receiving antenna device 90 comprises a receiving antenna module 910, an in-vehicle module 920, and a single cable 930 connected between the receiving antenna module 910 and the in-vehicle module 920. The receiving antenna module 910 comprises multiple antennas, multiple LNAs, multiple pre-filters, and a signal combination unit, wherein the multiple pre-filters are arranged between the multiple antennas and the signal combination unit for filtering noise from the multiple antennas. Each of the pre-filter can be arranged before one of the multiple LNAs or can be arranged between two of the multiple LNAs. To be more specific, a FM antenna 911a is connected to a signal combination unit 913 with a pre-filter 914a and a LNA 912a in between, wherein the pre-filter 914a is connected to the FM antenna 911a before the LNA 912a; a GPS antenna 911b is connected to the signal combination unit 913 with a pre-filter 914b, a LNA 912b, and a LNA 912c in between, wherein the pre-filter 914b is arranged between the LNA 912b and the LNA 912c. The in-vehicle module 920 is similar to the in-vehicle module 120 in FIG. 1, the in-vehicle module 220 in FIG. 2, the in-vehicle module 420 in FIG. 4, the in-vehicle module 620 in FIG. 6, and the in-vehicle module 820 in FIG. 8, such that the in-vehicle module 920 comprises a signal separation unit for splitting a mixed-band signal into at least two of single-band signals, dual-band signals and/or multi-band signals, and the in-vehicle module 920 can also receive power from an in-vehicle system or an external power source in order to provide power to multiple LNAs.

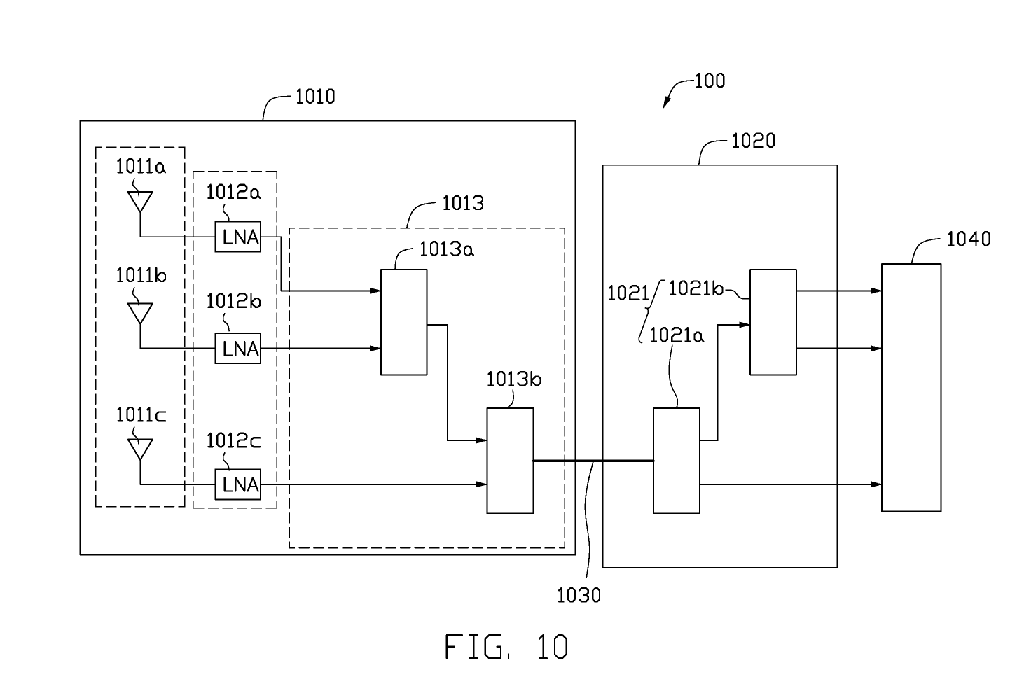

Referring to FIG. 10, which schematically illustrates a tenth embodiment of the receiving antenna device in the present disclosure. The receiving antenna device 100 comprises a receiving antenna module 1010, an in-vehicle module 1020 and a single cable 1030 connected between the receiving antenna module 1010 and the in-vehicle module 1020. The receiving antenna module 1010 comprises multiple antennas, one or more LNA, and multiple signal combination units, wherein the multiple signal combination units form two stages of signal combination, such that part of signals from part of the multiple antennas are combined in the first stage of the signal combination to output a first sub-mixed-band signal, and the rest of signals from rest of the multiple antennas are combined with the first sub-mixed-band signal in the second stage of the signal combination to output a mixed-band signal. Three single-band antennas with three LNAs and two signal combination units will be used for illustration as an example of this embodiment.

The three single-band antennas are FM antenna 1011a, GPS antenna 1011b, and digital TV antenna 1011c. The three LNAs are LNA 1012a, LNA 1012b, and LNA 1012c. The two signal combination units are first signal combination unit 1013a and second signal combination unit 1013b. As shown in FIG. 10, the FM antenna 1011a is connected to the LNA 1012a and then to the first signal combination unit 1013a, and the GPS antenna 1011b is connected to the LNA 1012b and then to the first signal combination unit 1013a as well, such that a FM signal from the FM antenna 1011a and a GPS signal from the GPS antenna 1011b are sent to the LNA 1012a and the LNA 1012b respectively for signal amplification before the first stage signal combination in the first signal combination unit 1013a. Thus, a first sub-mixed-band signal comprising the FM signal and the GPS signal is outputted by the first signal combination unit 1013a to the second signal combination unit 1013b. The digital TV antenna 1011c is connected to the LNA 1012c and then to the second signal combination unit 1013b, such that a digital TV signal from the digital TV antenna 1011c is amplified by the LNA 1012c and sent to the second signal combination unit 1013b for second stage of signal combination. Hence, the second signal combination unit 1013b combines the amplified digital TV signal from the LNA 1012c and the first sub-mixed-band signal into a mixed-band signal, which is outputted to the in-vehicle module 1020 via the single cable 1030.

In another embodiment of the present disclosure, the receiving antenna module 1010 can also comprise a LNA instead of the three LNAs, such that the LNA is connected after the second signal combination unit 1013b. Alternatively, the receiving antenna module 101 can also comprise two LNAs instead of the three LNAs, such that one of the two LNA is connected between the digital TV antenna 1011c and the second signal combination unit 1013b, and the other one of the two LNA is connected between the first signal combination unit 1013a and the second signal combination unit 1013b.

Though only two stages of signal combination are shown in FIG. 10, it should be apparent to any person having ordinary skill that the receiving antenna device 1010 can further comprise one or more signal combination units connected between multiple antennas and the single cable 1030 when the receiving antenna device 1010 needs to receive more radio signals with more antennas and/or multi band antennas, such that three or more stages of signal combination can be achieved.

The in-vehicle module 1020 with two stages of signal separation unit comprises multiple signal separation units, wherein the multiple signal separation units are a first signal separation unit 1021a in first stage of signal separation unit and a second signal separation unit 1022b in second stage of signal separation unit. In the first stage of signal separation unit, the first signal separation unit 1021a splits the mixed-band signal from the single cable 1030 into a second sub-mixed-band signal and a single-band signal, wherein the single-band signal is sent to an in-vehicle system 1040, while the second sub-mixed-band signal is sent to the second signal separation unit 1021b for second stage of signal separation unit; and, in the second stage of signal separation unit, the second signal separation unit 1021b splits the second sub-mixed-band signal into two single-band signals, which are sent to the in-vehicle system 1040. For example, the mixed-band signal from the single cable 1030 comprises the FM signal, the GPS signal, and the digital TV signal, such that one of the FM signal, the GPS signal, and the digital TV signal is split from the rest of the two in the first stage of signal separation unit by the first signal separation unit 1021a. If the signal output by the first stage of signal separation unit was the digital TV signal and the second sub-mixed-band signal, then the second sub-mixed-band signal should comprise the FM signal and the GPS signal. Hence, the second sub-mixed-band signal is further split into the FM signal and the GPS signal in the second stage of signal separation unit by the second signal separation unit 1021b. Therefore, the mixed-band signal is split into the FM signal, the GPS signal, and the digital TV signal by two stages of signal separation unit using the first signal separation unit 1021a and the second signal separation unit 1021b.

Though only two stages of signal separation unit are shown in FIG. 10, it should be apparent to any person having ordinary skill that the receiving antenna device 1010 can further comprise one or more signal separation units connected between the single cable 1030 and the in-vehicle system 1040 when the mixed-band signal comprises more radio signals from more antennas and/or multi band antennas within the receiving antenna module 1010, such that three or more stages of signal separation unit can be achieved.

In other embodiments of the present disclosure, the in-vehicle module 1020 can also employ similar structures as the in-vehicle module 120 in FIG. 1, the in-vehicle module 220 in FIG. 2, the in-vehicle module 420 in FIG. 4, the in-vehicle module 620 in FIG. 6, the in-vehicle module 820 in FIG. 8, or the in-vehicle module 920 in FIG. 9. Alternatively, the structures in the in-vehicle module 320 in FIG. 3, the in-vehicle module 520 in FIG. 5, or the in-vehicle module 720 in FIG. 7 are also applicable in the in-vehicle module 1020.

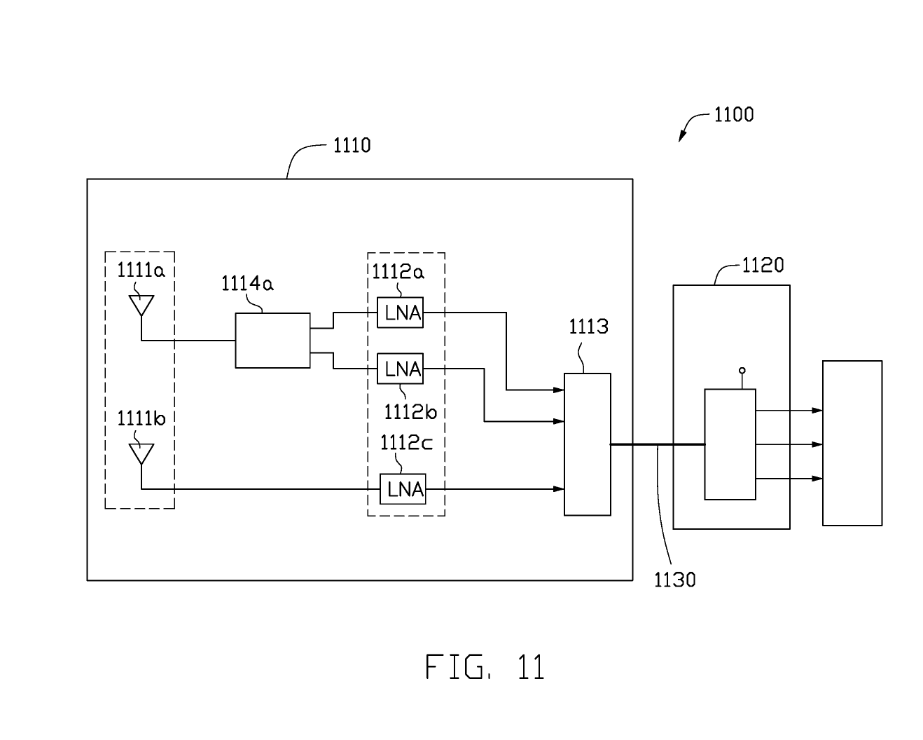

Referring to FIG. 11, which schematically illustrates an eleventh embodiment of the receiving antenna device in the present disclosure, the receiving antenna device 110 comprises a receiving antenna module 1110, an in-vehicle module 1120 and a single cable 1130 connected between the receiving antenna module 1110 and the in-vehicle module 1120. The receiving antenna module 1110 comprises at least one antenna, multiple LNAs, at least one signal combination unit, and at least one signal separation unit. The at least one antenna comprises at least one multi band antenna. The at least one signal separation unit is arranged after the at least one antenna for splitting a multi band signal into multiple single-band signals in different bands from each other. In the following description, two dual-band antennas, three LNAs, a signal combination unit, and two signal separation units are used as an example of this embodiment.

The receiving antenna module 1110 comprises a first antenna 1111a, a second antenna 1111b, a first signal separation unit 1114a, three LNAs (1112a, 1112b, 1112c), and a signal combination unit 1113, wherein the first antenna 1111a and the second antenna 1111b are at least one of dual-band antennas and multi-band antennas. The first signal separation unit 1114a is connected after the first antenna 1111a for splitting a dual-band signal (or a multi-band) into a first single-band signal and a second single-band signal, which are sent to the LNA 1112a and the LNA 1112b respectively for signal amplification. Therefore, the first single-band signal and the second single-band signal are transmitted to the signal combination unit 1113 after signal amplification by the LNA 1112a and the LNA 1112b. The LNA 1112c is connected after the second antenna 1111b for amplifying a dual-band signal therefrom, such that the LNA 1112c sends the amplified dual-band signal to the signal combination unit 1113. Thus, the signal combination unit 1113 combines the first single-band signal, the second single-band signal and the third single-band signal into a mixed-band signal, which is sent to the in-vehicle module 1120 via the single cable 1130.

In another embodiment of the present disclosure, the receiving antenna module 1110 can comprise only one LNA to be connected after the signal combination unit 1113; else, the receiving antenna module 1110 can comprise two LNAs instead of three LNAs, wherein one of the two LNAs is connected before the first signal separation unit 1114a, and the other LNA of the two LNAs is connected after signal combination unit 1113. Alternatively, the receiving antenna module 1110 can comprise four or more LNAs to be arranged between the signal separation unit 1114a and the signal combination unit 1113. The signal separation units is composed of one or more filters, for example, high pass filter, low pass filter, band stop filter, band pass filter, notch filter, or any combination thereof.

In this embodiment of the present disclosure, the in-vehicle module 1120 is similar to the in-vehicle module 120 in FIG. 1, the in-vehicle module 220 in FIG. 2, the in-vehicle module 420 in FIG. 4, the in-vehicle module 620 in FIG. 6, the in-vehicle module 820 in FIG. 8, or the in-vehicle module 920 in FIG. 9. Alternatively, the structures in the in-vehicle module 320 in FIG. 3, the in-vehicle module 520 in FIG. 5, the in-vehicle module 720 in FIG. 7, or the in-vehicle module 1020 in FIG. 10 are also applicable in the in-vehicle module 1120.

FIG. 12 schematically illustrates a twelfth embodiment of the receiving antenna device in the present disclosure. The receiving antenna device 120 comprises a receiving antenna module 1210, an in-vehicle module 1220 and a single cable 1230 connected between the receiving antenna module 1210 and the in-vehicle module 1220. The receiving antenna module 1210 comprises multiple antennas, at least one signal separation unit, multiple LNAs, and multiple signal combination units. The multiple signal combination units form two stages of signal combination. In the following description, two antennas, one signal separation unit, three LNAs, and two signal combination units will be used as an example according to this embodiment.

The receiving antenna module 1210 comprises a first antenna 1211a, a second antenna 1211b, a signal separation unit 1214, three LNAs (1212a, 1212b, 1212c), and a first signal combination unit 1213a, and a second signal combination unit 1213b, wherein the first antenna 1211a and the second antenna 1211b may a dual-band antenna or a multi-band antenna. The first antenna 1211a sends a first dual-band signal (or multi-band) to the signal separation unit 1214, such that the signal separation unit 1214 splits the first dual-band signal into a first single-band signal and a second single-band signal, that are sent to the LNA 1212a and the LNA 1212b respectively for signal amplification. The amplified first single-band signal and the amplified second single-band signal are sent to the first signal combination unit 1213a for first stage of signal combination by the LNA 1212a and the LNA 1212b respectively, such that the first signal combination unit 1213a outputs a sub-mixed-band signal to the second signal combination unit 1213b for second stage of signal combination. The LNA 1212c is arranged after the second antenna 1211b for amplifying a dual-band signal therefrom, and the amplified dual-band signal is sent to the second signal combination unit 1213b for second stage of signal combination. Therefore, the second signal combination unit 1213b combines the sub-mixed-band signal and the amplified dual-band signal into a mixed-band signal, which is sent to the in-vehicle module 1220 via the single cable 1230.

In this embodiment of the present disclosure, the in-vehicle module 1220 is similar to the in-vehicle module 120 in FIG. 1, the in-vehicle module 220 in FIG. 2, the in-vehicle module 420 in FIG. 4, the in-vehicle module 620 in FIG. 6, the in-vehicle module 820 in FIG. 8, or the in-vehicle module 920 in FIG. 9. Alternatively, the structures in the in-vehicle module 320 in FIG. 3, the in-vehicle module 520 in FIG. 5, the in-vehicle module 720 in FIG. 7, or the in-vehicle module 1020 in FIG. 10 are also applicable in the in-vehicle module 1220.

According to the above embodiments of the present disclosure, the receiving antenna module and the in-vehicle module are connected to each other by a single cable, which transmits a mixed-band signal from the receiving antenna module to the in-vehicle module. The receiving antenna module can comprise one or more antennas, wherein the one or more antennas can be single-band antenna, dual-band antenna, multi-band antenna or a combination thereof. The one or more antenna can be micro strip antenna (as known as patch antenna), for example: micro strip antenna with ceramic substrate, planar single pole antenna, or stereoscopic single pole antenna, but not limited thereto. The LNA can be arranged anywhere between the one or more antennas and the single cable as long as the bandwidth of the LNA covers the bandwidth of the signal to be amplified. The receiving antenna module can comprise one or more signal combination units to form at least one stage of signal combination, wherein the number of signal combination units and the number of stage of signal combination are depend on the number of signals in different band. Additionally, a pre-filter can be arranged after the one or more antennas for filtering noise therefrom. If the one or more antennas comprise a multi band antenna, a signal separation unit can be employed for signal separation unit, such that outputs single-band signals for easy signal processing. In the in-vehicle module, one or more signal separation unit can be employed, so as to form at least one stage of signal separation unit, wherein the number of stage of signal separation unit is depended on number of different bands within the mixed-band signal. The in-vehicle module can receive power from an in-vehicle system or any other external power source to provide power to the one or more LNA.

Furthermore, the receiving antenna module can be installed with a base and a casing so as to form an antenna box; and, the in-vehicle module can be installed with a base and a casing as well. Of course, the in-vehicle module can also be integrated within the in-vehicle system to share the base and the casing thereof.

FIG. 13 schematically illustrates a first embodiment of a signal combination unit in the receiving antenna device in the present disclosure. The signal combination unit 1300 comprises a first input 1301a, a second input 1301b, a third input 1301c, and an output 1302, wherein each of the three inputs (1301a, 1301b, and 1301c) receives a signal having different bands from the other two. Therefore, the signal combination unit 1300 combines three signals in different bands into a mixed-band signal and outputs the mixed-band signal through the output 1302, wherein the three signals can be single-band signals, dual-band signals, multi-band signals, or any combination thereof. In this embodiment, three single-band signals, which are FM signal, GPS signal, and digital TV signal, are used as an example for the following illustration.

Within the signal combination unit 1300, three branch circuits are present, such that a branch circuit 1303a is arranged between the first input 1301a and the output 1302, a second branch circuit 1303b is arranged between the second input 1301b and the output 1302, and a third branch circuit 1303c is arranged between the third input 1301c and the output 1302, wherein the three branch circuits intersect with each other at a common point H before the output 1302. Every branch circuit has a matching circuit and two filter circuits, wherein the matching circuit matches the impedance difference between the corresponding input signal and the filter circuits in order to ensure signal integrity. The first branch circuit 1303a comprise a first matching circuit 1304a, a second filter circuit 1305a, and a third filter circuit 1306a, such that the FM signal enters the first branch circuit 1303a via the first input 1301a and passes the first matching circuit 1304a, the second filter circuit 1305a, and the third filter circuit 1306a in the order described, wherein the second filter circuit 1305a removes a part of frequency band corresponding to the GPS signal from the FM signal, and the third filter circuit 1306a removes a part of frequency band corresponding to the digital TV signal from the FM signal. Thus, a filtered FM signal is sent to the common point H. The second branch circuit 1303b comprise a second matching circuit 1304b, a first filter circuit 1305b, and a third filter circuit 1306b, such that the GPS signal enters the second branch circuit 1303b via the second input 1301b and passes the second matching circuit 1304b, the first filter circuit 1305b, and the third filter circuit 1306b in the order described, wherein the first filter circuit 1305b removes a part of frequency band corresponding to the FM signal from the GPS signal, and the third filter circuit 1306b removes a part of frequency band corresponding to the digital TV signal from the GPS signal. Thus, a filtered GPS signal is sent to the common point H. The third branch circuit 1303c comprise a third matching circuit 1304c, a first filter circuit 1305c, and a second filter circuit 1306c, such that the digital TV signal enters the third branch circuit 1303c via the third input 1301c and passes the third matching circuit 1304c, the first filter circuit 1305c, and the second filter circuit 1306c in the order described, wherein the first filter circuit 1305c removes a part of frequency band corresponding to the FM signal from the digital TV signal, and the second filter circuit 1306c removes a part of frequency band corresponding to the GPS signal from the digital TV signal. Thus, a filtered digital TV signal is sent to the common point H. Therefore, the signal combination unit 1300 combines the filtered FM signal, the filtered GPS signal, and the filtered digital TV signal into a mixed-band signal at the common point H and outputs the mixed-band signal, which comprises the FM frequency band, the GPS frequency band, and the digital TV frequency band, via the output 1302. In another embodiment, the common point H is arranged at the output 1302.

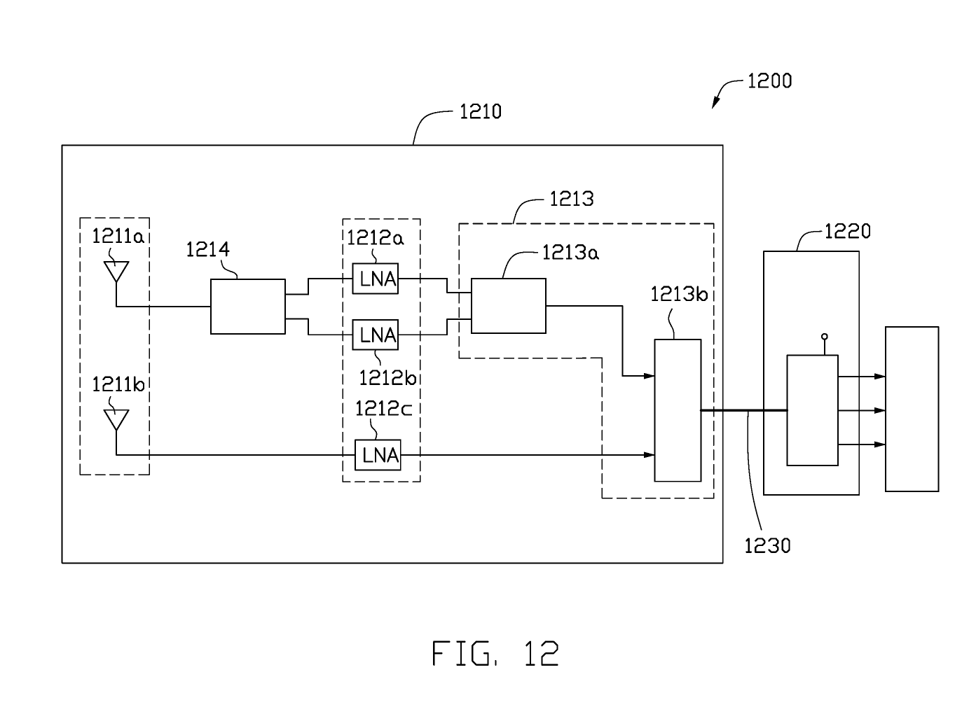

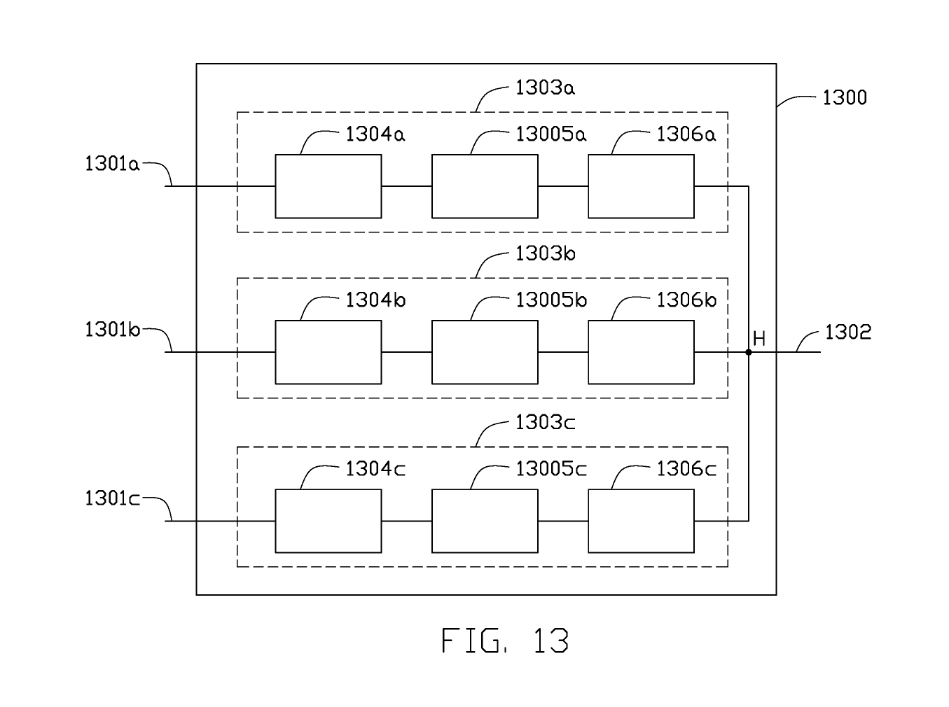

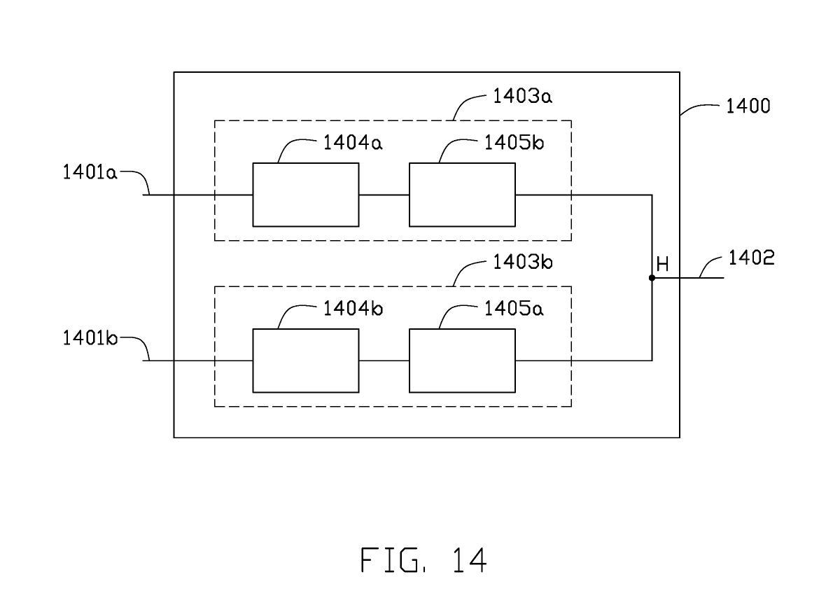

FIG. 14 schematically illustrates a second embodiment of the signal combination unit in the receiving antenna device in the present disclosure. The signal combination unit 1400 comprises a first input 1401a, a second input 1401b, and an output 1402, wherein each of the two inputs (1401a, 1401b) receives a signal having different band from the other. Therefore, the signal combination unit 1400 combines two signals in different bands into a mixed-band signal and outputs the mixed-band signal through the output 1402, wherein the two signals can be single-band signals, dual-band signals, multi band signals, or any combination thereof. In this embodiment, two single-band signals, which are a FM signal and a GPS signal, are used as an example for the following illustration.

Within the signal combination unit 1400, two electrical branch circuits are present, such that a first branch circuit 1403a is arranged between the first input 1401a and the output 1402, and a second branch circuit 1403b is arranged between the second input 1401b and the output 1402, wherein the two branch circuits intersect with each other at a common point H before the output 1402. Every branch circuit has a matching circuit and a filter circuit, wherein the matching circuit matches the impedance difference between the corresponding input signal and the filter circuit in order to ensure signal integrity. The first branch circuit 1403a comprise a first matching circuit 1404a and a second filter circuit 1405b, such that the FM signal enters the first branch circuit 1403a via the first input 1401a and passes the first matching circuit 1404a and the second filter circuit 1405b in the order described, wherein the second filter circuit 1405b removes a part of frequency band corresponding to the GPS signal from the FM signal. Thus, a filtered FM signal is sent to the common point H. The second branch circuit 1403b comprise a second matching circuit 1404b and a first filter circuit 1405a, such that the GPS signal enters the second branch circuit 1403b via the second input 1401b and passes the second matching circuit 1404a and the first filter circuit 1405a in the order described, wherein the first filter circuit 1405a removes a part of frequency band corresponding to the FM signal from the GPS signal. Thus, a filtered GPS signal is sent to the common point H. Therefore, the signal combination unit 1400 combines the filtered FM signal and the filtered GPS signal into a mixed-band signal at the common point H and outputs the mixed-band signal, which comprises the FM frequency band and the GPS frequency band, via the output 1402. In another embodiment, the common point H is arranged at the output 1402.

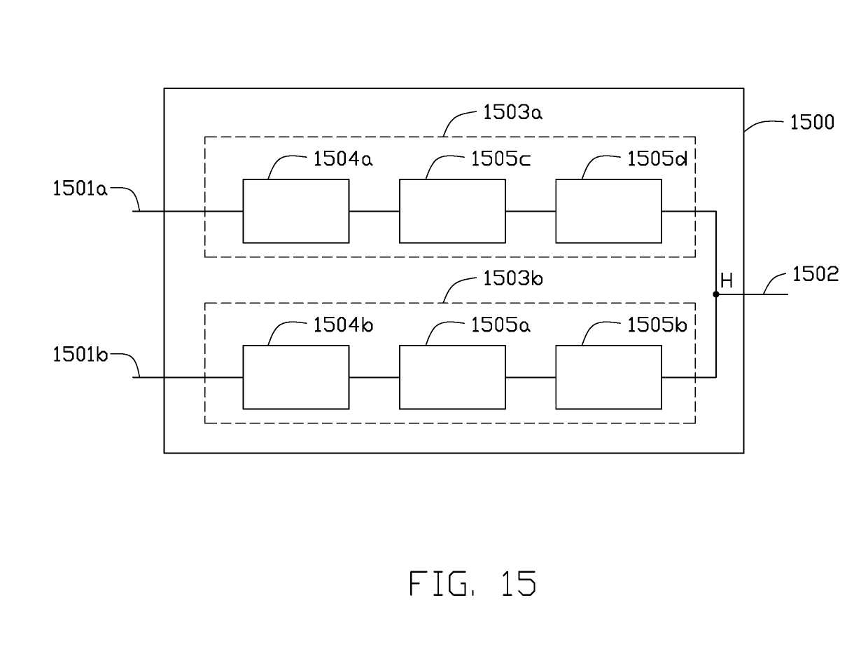

FIG. 15 schematically illustrates a third embodiment of the signal combination unit in the receiving antenna device in the present disclosure. The signal combination unit 1500 comprises a first input 1501a, a second input 1501b, and an output 1502, wherein each of the two inputs (1501a, 1501b) receives a signal having different band from the other two. Therefore, the signal combination unit 1500 combines two signals in different bands into a mixed-band signal and outputs the mixed-band signal through the output 1502, wherein the three signals can be single-band signals, multi band signals, or any combination thereof. In this embodiment, two dual-band signals, that are a first mixed-band signal comprising a FM frequency band and a GPS frequency band, and a second mixed-band signal comprising digital a TV frequency band and a DAB frequency band, are used as an example for the following illustration.

Within the signal combination unit 1500, two electrical branch circuits are present, such that a first branch circuit 1503a is arranged between the first input 1501a and the output 1502, and a second branch circuit 1503b is arranged between the second input 1501b and the output 1502, wherein the two branch circuits intersect with each other at a common point H before the output 1502. Every branch circuit has a matching circuit and two filter circuits, wherein the matching circuit matches the impedance difference between the corresponding input signal and the filter circuits in order to ensure signal integrity. The first branch circuit 1503a comprise a first matching circuit 1504a, a third filter circuit 1505c, and a fourth filter circuit 1505d, such that the first mixed-band signal enters the first branch circuit 1503a via the first input 1501a and passes the first matching circuit 1504a, the third filter circuit 1505c, and the fourth filter circuit 1505d in the order described, wherein the third filter circuit 1505c removes the digital TV frequency band from the first mixed-band signal, and the fourth filter circuit 1505d removes the DAB frequency band from the first mixed-band signal. Thus, a filtered first mixed-band signal is sent to the common point H. The second branch circuit 1503b comprise a second matching circuit 1504b, a first filter circuit 1505a, and a second filter circuit 1505b, such that the second mixed-band signal enters the second branch circuit 1503b via the second input 1501b and passes the second matching circuit 1504a, the first filter circuit 1505a, and the second filter circuit 1505b in the order described, wherein the first filter circuit 1505a removes the FM frequency band from the second mixed-band signal, and the second filter circuit 1505b removes the GPS frequency band from the second mixed-band signal. Thus, a filtered second mixed-band signal is sent to the common point H. Therefore, the signal combination unit 1500 combines the filtered first mixed-band signal and the filtered second mixed-band signal into a third mixed-band signal at the common point H and outputs the third mixed-band signal, which comprises the FM frequency band, the GPS frequency band, the digital TV frequency band, and the DAB frequency band, via the output 1502. In another embodiment, the common point H is arranged at the output 1502.

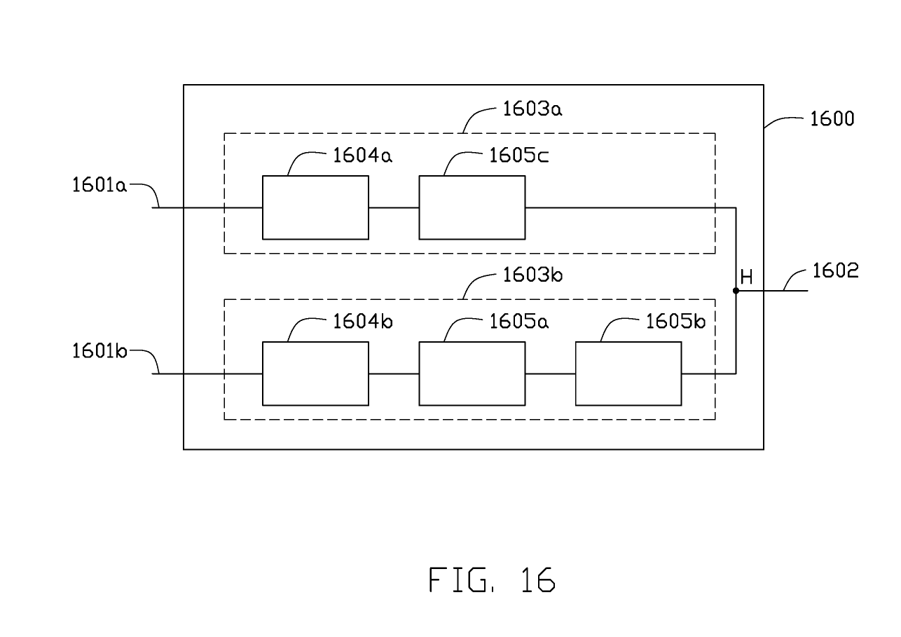

FIG. 16 schematically illustrates a fourth embodiment of the signal combination unit in the receiving antenna device in the present disclosure. The signal combination unit 1600 comprises a first input 1601a, a second input 1601b, and an output 1602, wherein each of the two inputs (1601a, 1601b) receives a signal having different band from the other two. Therefore, the signal combination unit 1600 combines two signals in different bands into a mixed-band signal and outputs the mixed-band signal through the output 1602, wherein the three signals can be single-band signals, multi band signals, or any combination thereof. In this embodiment, a dual-band signal and a single-band signal, that are a first mixed-band signal comprising a FM frequency band and a GPS frequency band, and a digital TV signal, are used as an example for the following illustration.

Within the signal combination unit 1600, two electrical branch circuits are present, such that a first branch circuit 1603a is arranged between the first input 1601a and the output 1602, and a second branch circuit 1603b is arranged between the second input 1601b and the output 1602, wherein the two branch circuits intersect with each other at a common point H before the output 1602. Every branch circuit has a matching circuit and at least one filter circuit, wherein the matching circuit matches the impedance difference between the corresponding input signal and the at least one filter circuit in order to ensure signal integrity. The first branch circuit 1603a comprise a first matching circuit 1604a and a third filter circuit 1605c, such that the first mixed-band signal enters the first branch circuit 1603a via the first input 1601a and passes the first matching circuit 1604a and the third filter circuit 1605c in the order described, wherein the third filter circuit 1605c removes a part of frequency band corresponding to the digital TV signal from the first mixed-band signal. Thus, a filtered first mixed-band signal is sent to the common point H. The second branch circuit 1603b comprise a second matching circuit 1604b, a first filter circuit 1605a, and a second filter circuit 1605b, such that the digital TV signal enters the second branch circuit 1603b via the second input 1601b and passes the second matching circuit 1604a, the first filter circuit 1605a, and the second filter circuit 1605b in the order described, wherein the first filter circuit 1605a removes the FM frequency band from the digital TV signal, and the second filter circuit 1605b removes the GPS frequency band from the digital TV signal. Thus, a filtered digital TV signal is sent to the common point H. Therefore, the signal combination unit 1600 combines the filtered first mixed-band signal and the digital TV signal into a second mixed-band signal at the common point H and outputs the second mixed-band signal, which comprises the FM frequency band, the GPS frequency band, and the digital TV frequency band, via the output 1602. In another embodiment, the common point H is arranged at the output 1602.

Though only FM signal, GPS signal, digital TV signal, DAB signal, or mixed-band signals comprising any of the above are used, it should be apparent to any person having ordinary skill that the filter circuits of the signal combination unit can be modified to enable the signal combination unit combining any type of signals in different bands into a mixed-band signal.

In addition, any filter circuit mentioned above is a band stop filter, more specifically, a notch filter. However, in other embodiments of the present disclosure, the filter circuit can be high pass filter, low pass filter, bandpass filter, or any combination thereof.

Moreover, if any high pass filter and/or bandpass filter is connected to a branch circuit within a signal combination unit, the signal combination unit can further comprise an inductor connected in parallel to the branch circuit in order to provide power to a LNA connected before the signal combination unit, wherein the power can be from an in-vehicle module, an in-vehicle system, or any external source.

FIG. 17 schematically illustrates a first embodiment of a signal separation unit in the receiving antenna device in the present disclosure. The signal separation unit 1700 comprises an input 1701, a first output 1702a, a second output 1702b, and a third output 1702c, wherein each of the three outputs (1702a, 1702b, and 1702c) outputs a signal having different band from the other two. Therefore, the signal separation unit 1700 splits a mixed-band signal comprising different bands into three signals and outputs the three signals through the three outputs, wherein the three signals can be single-band signals, multi band signals, or any combination thereof. In this embodiment, a mixed-band signal comprising a FM frequency band, a GPS frequency band, and a digital TV frequency band, is used as an example for the following illustration.

Within the signal separation unit 1700, three electrical branch circuits are present, such that a first branch circuit 1703a is arranged between the input 1701 and the first output 1702a, a second branch circuit 1703b is arranged between the input 1701 and the second output 1702b, and a third branch circuit 1703c is arranged between the input 1701 and the third output 1702c, wherein the three branch circuits intersect with each other at a common point O after the input 1701. Every branch circuit has two filter circuits and a matching circuit, wherein the matching circuit matches the impedance difference between the corresponding output signal and the filter circuits in order to ensure signal integrity. The first branch circuit 1703a comprise a second filter circuit 1705b, a third filter circuit 1705c, and a first matching circuit 1704a, such that the mixed-band signal from the input 1701 enters the first branch circuit 1703a and passes the second filter circuit 1705b, the third filter circuit 1705c, and the first matching circuit 1704a, in the order described, wherein the second filter circuit 1705b removes the GPS frequency band from the mixed-band signal, and the third filter circuit 1705c removes the digital TV frequency band from the mixed-band signal. Thus, a FM signal is outputted by the first output 1702a. The second branch circuit 1703b comprise a first filter circuit 1705a, a third filter circuit 1705c, and a second matching circuit 1704b, such that the mixed-band signal from the input 1701 enters the second branch circuit 1703b and passes the first filter circuit 1705a, the third filter circuit 1705c, and the second matching circuit 1704a in the order described, wherein the first filter circuit 1705a removes the FM frequency band from the mixed-band signal, and the third filter circuit 1705c removes the digital TV frequency band from the mixed-band signal. Thus, a GPS signal is outputted by the second output 1702b. The third branch circuit 1703c comprise a first filter circuit 1705a, a second filter circuit 1705b, and a third matching circuit 1704c, such that the mixed-band signal from the input 1701 enters the third branch circuit 1703c and passes the first filter circuit 1705a, the second filter circuit 1705b, and the third matching circuit 1704c in the order described, wherein the first filter circuit 1705a removes the FM frequency band from the mixed-band signal, and the second filter circuit 1705b removes the GPS frequency band from the mixed-band signal. Thus, a TV signal is outputted by the third output 1702c. Therefore, the signal separation unit 1700 splits the mixed-band signal comprising the FM frequency band, the GPS frequency band, and the digital TV frequency band into a FM signal, a GPS signal, and a digital TV signal and outputs by the first output 1702a, the second output 1702b, and the third output 1702c, respectively. In another embodiment, the common point O is arranged at the input 1701.

The signal separation unit 1700 can further comprise a power input 1707 similar to the power input 1213 in FIG. 1, wherein the power input 1707 is connected to the input 1701 with a low pass filter 1706 in between for receiving DC power from an in-vehicle system or other external power source.

FIG. 18 schematically illustrates a second embodiment of the signal separation unit in the receiving antenna device in the present disclosure. The signal separation unit 1800 comprises an input 1801, a first output 1802a, and a second output 1802b, wherein each of the two outputs (1802a, 1802b) outputs a signal having different band from the other. Therefore, the signal separation unit 1800 splits a mixed-band signal comprising different bands into two signals and outputs the two signals through the two outputs, wherein the two signals can be single-band signals, dual-band signals, multi-band signals, or any combination thereof. In this embodiment, a mixed-band signal comprising a FM frequency band and a GPS frequency band is used as an example for the following illustration.

Within the signal separation unit 1800, two electrical branch circuits are present, such that a first branch circuit 1803a is arranged between the input 1801 and the first output 1802a, and a second branch circuit 1803b is arranged between the input 1801 and the second output 1802b, wherein the two branch circuits intersect with each other at a common point O after the input 1801. Every branch circuit has a filter circuit and a matching circuit, wherein the matching circuit matches the impedance difference between the corresponding output signal and the filter circuit in order to ensure signal integrity. The first branch circuit 1803a comprise a second filter circuit 1805b and a first matching circuit 1804a, such that the mixed-band signal from the input 1801 enters the first branch circuit 1803a and passes the second filter circuit 1805b and the first matching circuit 1804a in the order described, wherein the second filter circuit 1805b removes the GPS frequency band from the mixed-band signal. Thus, a FM signal is outputted by the first output 1802a. The second branch circuit 1803b comprise a first filter circuit 1805a and a second matching circuit 1804b, such that the mixed-band signal from the input 1801 enters the second branch circuit 1803b and passes the first filter circuit 1805a and the second matching circuit 1804a in the order described, wherein the first filter circuit 1805a removes the FM frequency band from the mixed-band signal. Thus, a GPS signal is outputted by the second output 1802b. Therefore, the signal separation unit 1800 splits the mixed-band signal comprising the FM frequency band and the GPS frequency band into a FM signal and a GPS signal and outputs by the first output 1802a and the second output 1802b, respectively. In another embodiment, the common point O is arranged at the input 1801.

The signal separation unit 1800 can further comprise a power input 1807 similar to the power input 1213 in FIG. 1, wherein the power input 1807 is connected to the input 1801 with a low pass filter 1806 in between for receiving DC power from an in-vehicle system or other external power source.

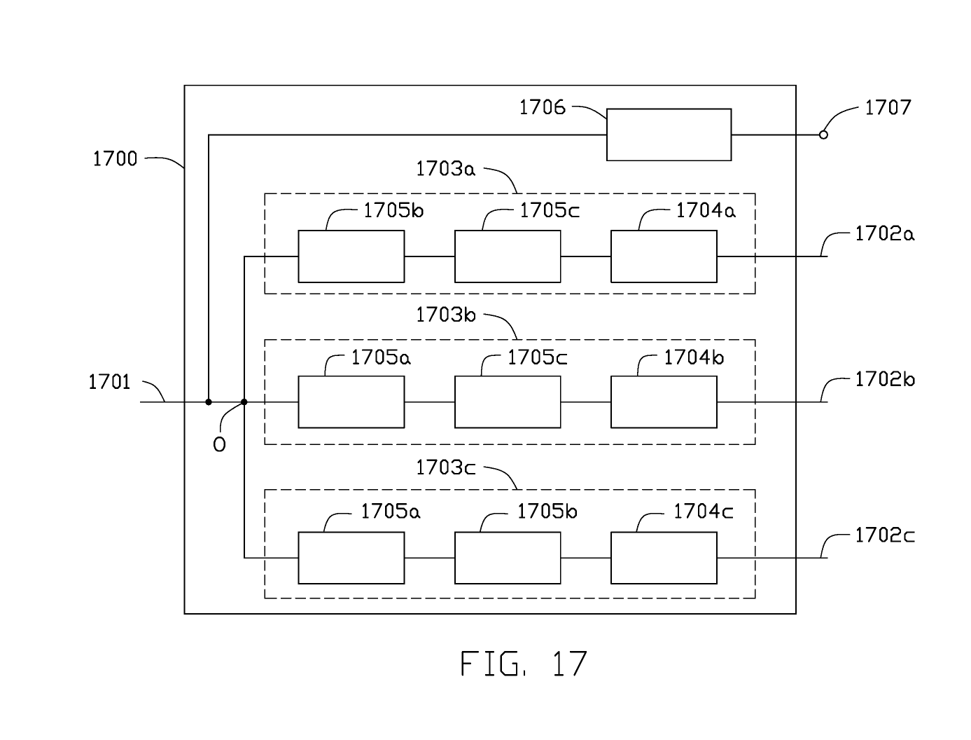

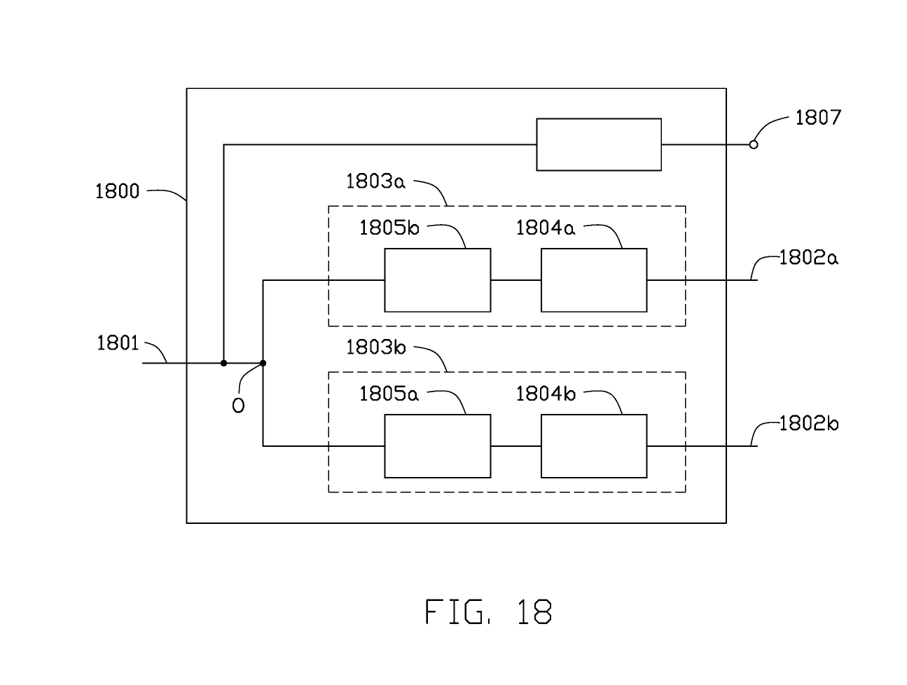

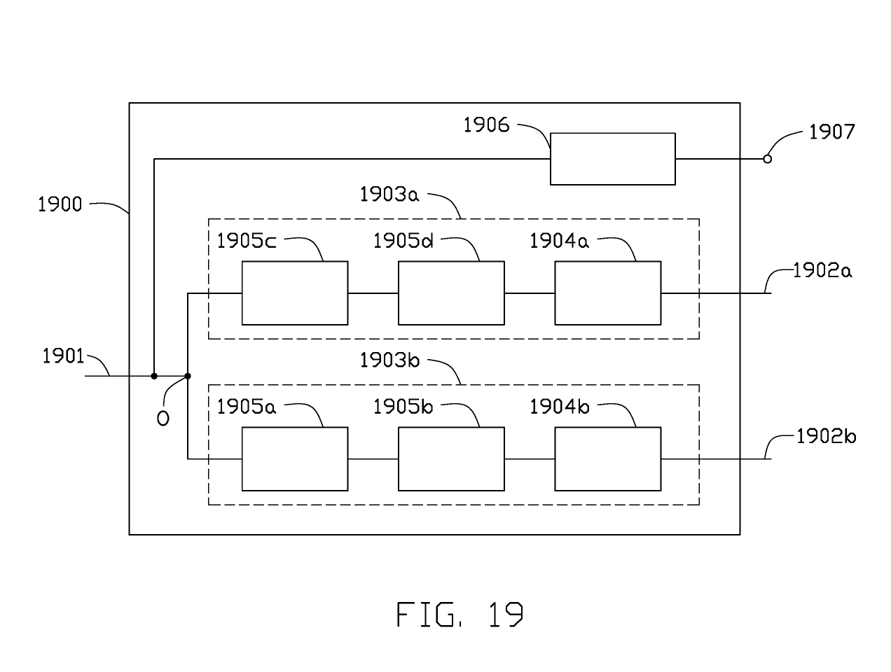

FIG. 19 schematically illustrates a third embodiment of the signal separation unit in the receiving antenna device in the present disclosure. The signal separation unit 1900 comprises an input 1901, a first output 1902a, and a second output 1902b, wherein each of the two outputs (1902a, 1902b) outputs a signal having different band from the other. Therefore, the signal separation unit 1900 splits a mixed-band signal comprising different bands into two signals and outputs the two signals through the two outputs, wherein the two signals can be single-band signals, multi band signals, or any combination thereof. In this embodiment, a first mixed-band signal comprising a FM frequency band, a GPS frequency band, a digital TV frequency band, and a DAB frequency band is used as an example for the following illustration.

Within the signal separation unit 1900, two electrical branch circuits are present, such that a first branch circuit 1903a is arranged between the input 1901 and the first output 1902a, and a second branch circuit 1903b is arranged between the input 1901 and the second output 1902b, wherein the two branch circuits intersect with each other at a common point O after the input 1901. Every branch circuit has two filter circuits and a matching circuit, wherein the matching circuit matches the impedance difference between the corresponding output signal and the filter circuits in order to ensure signal integrity. The first branch circuit 1903a comprise a third filter circuit 1905c, a fourth filter circuit 1905d, and a first matching circuit 1904a, such that the first mixed-band signal from the input 1901 enters the first branch circuit 1903a and passes the third filter circuit 1905c, the fourth filter circuit 1905d, and the first matching circuit 1904a in the order described, wherein the third filter circuit 1905c removes the digital TV frequency band from the first mixed-band signal, and the fourth filter circuit 1905d removes the DAB frequency band from the first mixed-band signal. Thus, a second mixed-band signal comprising the FM frequency band and the GPS frequency band is outputted by the first output 1902a. The second branch circuit 1903b comprise a first filter circuit 1905a, a second filter circuit 1905b, and a second matching circuit 1904b, such that the first mixed-band signal from the input 1901 enters the second branch circuit 1903b and passes the first filter circuit 1905a, the second filter circuit 1905b, and the second matching circuit 1904a in the order described, wherein the first filter circuit 1905a removes the FM frequency band from the first mixed-band signal, and the second filter circuit 1905b removes the GPS frequency band from the first mixed-band signal. Thus, a third mixed-band signal comprising the digital TV frequency band and the DAB frequency band is outputted by the second output 1902b. Therefore, the signal separation unit 1900 splits the first mixed-band signal comprising the FM frequency band, the GPS frequency band, the digital TV frequency band, and the DAB frequency band into the second mixed-band signal and the third mixed-band signal and outputs by the first output 1902a and the second output 1902b, respectively. In another embodiment, the common point O is arranged at the input 1901.

The signal separation unit 1900 can further comprise a power input 1907 similar to the power input 1213 in FIG. 1, wherein the power input 1907 is connected to the input 1901 with a low pass filter 1906 in between for receiving DC power from an in-vehicle system or other external power source.

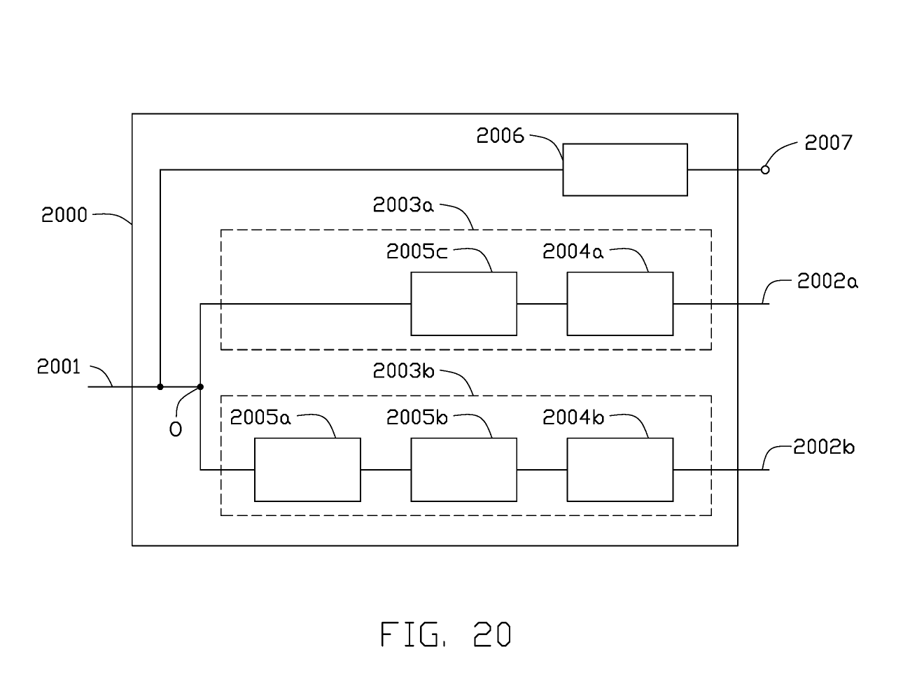

FIG. 20 schematically illustrates a fourth embodiment of the signal separation unit in the receiving antenna device in the present disclosure. The signal separation unit 2000 comprises an input 2001, a first output 2002a, and a second output 2002b, wherein each of the two outputs (2002a, 2002b) outputs a signal having different band from the other. Therefore, the signal separation unit 2000 splits a mixed-band signal comprising different bands into two signals and outputs the two signals through the two outputs, wherein the two signals can be single-band signals, multi band signals, or any combination thereof. In this embodiment, a first mixed-band signal comprising a FM frequency band, a GPS frequency band, and a digital TV frequency band is used as an example for the following illustration.

Within the signal separation unit 2000, two electrical branch circuits are present, such that a first branch circuit 2003a is arranged between the input 2001 and the first output 2002a, and a second branch circuit 2003b is arranged between the input 2001 and the second output 2002b, wherein the two branch circuits intersect with each other at a common point O after the input 2001. Every branch circuit has at least one filter circuit and a matching circuit, wherein the matching circuit matches the impedance difference between the corresponding output signal and the at least one filter circuit in order to ensure signal integrity. The first branch circuit 2003a comprise a third filter circuit 2005c and a first matching circuit 2004a, such that the first mixed-band signal from the input 2001 enters the first branch circuit 2003a and passes the third filter circuit 2005c and the first matching circuit 2004a in the order described, wherein the third filter circuit 2005c removes the digital TV frequency band from the first mixed-band signal. Thus, a second mixed-band signal comprising the FM frequency band and the GPS frequency band is outputted by the first output 2002a. The second branch circuit 2003b comprise a first filter circuit 2005a, a second filter circuit 2005b, and a second matching circuit 2004b, such that the first mixed-band signal from the input 2001 enters the second branch circuit 2003b and passes the first filter circuit 2005a, the second filter circuit 2005b, and the second matching circuit 2004a in the order described, wherein the first filter circuit 2005a removes the FM frequency band from the first mixed-band signal, and the second filter circuit 2005b removes the GPS frequency band from the first mixed-band signal. Thus, a digital TV signal is outputted by the second output 2002b. Therefore, the signal separation unit 2000 splits the first mixed band signal comprising the FM frequency band, the GPS frequency band, the digital TV frequency band, and the DAB frequency band into the second mixed-band signal and the digital TV signal and outputs by the first output 2002a and the second output 2002b, respectively. In another embodiment, the common point O is arranged at the input 2001.

The signal separation unit 2000 can further comprise a power input 2007 similar to the power input 1213 in FIG. 1, wherein the power input 2007 is connected to the input 2001 with a low pass filter 2006 in between for receiving DC power from an in-vehicle system or other external power source.

Though only mixed-band signal comprising the FM frequency band, the GPS frequency band, the digital TV frequency band, and the DAB frequency band is used, it should be apparent to any person having ordinary skill that the filter circuits of the signal separation unit can be modified to enable the signal separation unit splitting any type of mixed-band signal comprising any different frequency bands into multiple signal.

In addition, any filter circuit mentioned above is a band stop filter, more specifically, a notch filter. However, in other embodiments of the present disclosure, the filter circuit can be high pass filter, low pass filter, bandpass filter, or any combination thereof.

Furthermore, any branch circuit within the signal separation unit can further comprise a capacitor connected after the input in series in order to isolate the DC power from the in-vehicle system.

FIG. 21 schematically illustrates a circuit diagram for a first embodiment of the matching circuit according to the present disclosure. Matching circuit 2100 includes at least one inductor 2101 which is connected in series between upstream and downstream circuits. Specifically, inductor 2101 is connected in series to an input of the signal combination unit when used for the signal combination unit. The inductor 2101 is connected in series to an output of the signal separation unit when used for the signal separation unit.

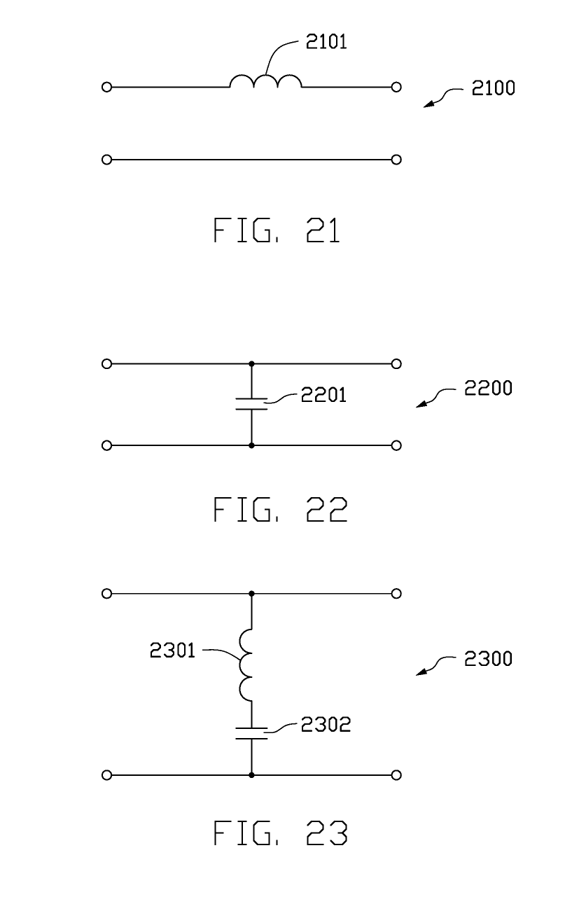

FIG. 22 schematically illustrates a circuit diagram for a second embodiment of the matching circuit according to the present disclosure. Matching circuit 2200 includes at least one capacitor 2201 which is connected in parallel between upstream and downstream circuits. Specifically, capacitor 2201 is connected in parallel to an input of the signal combination unit when used for the signal combination unit. Capacitor 2201 is connected in parallel to an output of the signal separation unit when used for the signal separation unit.

FIG. 23 schematically illustrates a circuit diagram for a third embodiment of the matching circuit according to the present disclosure. Matching circuit 2300 includes at least one inductor 2301 and at least one capacitor 2302 which are connected to each other in series and connected in parallel between upstream and downstream circuits. Specifically, inductor 2301 and capacitor 2302 are connected to each other in series, followed by a parallel connection to an input of the signal combination unit when used for the signal combination unit. Inductor 2301 and capacitor 2302 are connected to each other in series, followed by a parallel connection to an output of signal separation unit when used for the signal separation unit.

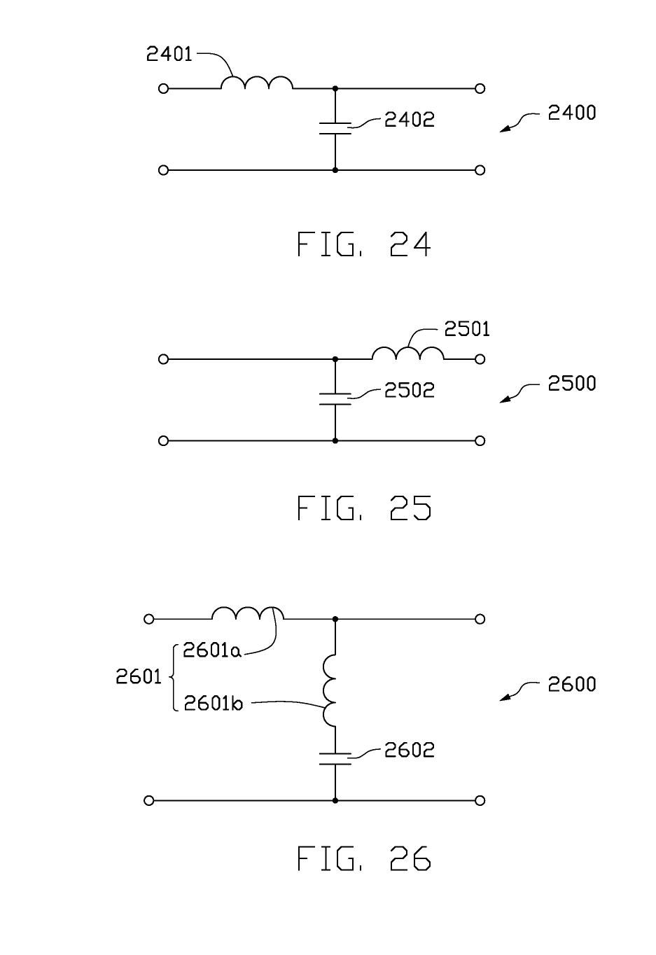

FIG. 24 schematically illustrates a circuit diagram for a fourth embodiment of the matching circuit according to the present disclosure. Matching circuit 2400 includes at least one inductor 2401 and at least one capacitor 2402. Inductor 2401 is connected in series between upstream and downstream circuits. Capacitor 2402 is connected in parallel between the upstream and downstream circuits and arranged at the back of inductor 2401. Specifically, inductor 2401 is connected in series to an input of the signal combination unit, and capacitor 2402 is connected in parallel to the input of the signal combination unit and arranged at the back of inductor 2401 when used for the signal combination unit. Inductor 2401 is connected in series to an output of the signal separation unit, and capacitor 2402 is connected in parallel to the output of the signal separation unit and arranged at the back of inductor 2401 when used for the signal separation unit.

FIG. 25 schematically illustrates a circuit diagram for a fifth embodiment of the matching circuit according to the present disclosure. Matching circuit 2500 includes at least one inductor 2501 and at least one capacitor 2502. Inductor 2501 is connected in series between upstream and downstream circuits. Capacitor 2502 is connected in parallel between the upstream and downstream circuits and arranged at the front of inductor 2501. Specifically, inductor 2501 is connected in series to an input of the signal combination unit, and capacitor 2502 is connected in parallel to the input of the signal combination unit and arranged at the front of inductor 2501 when used for the signal combination unit. Inductor 2501 is connected in series to an output of the signal separation unit, and capacitor 2502 is connected in parallel to the output of the signal separation unit and arranged at the front of inductor 2501 when used for the signal separation unit.

FIG. 26 schematically illustrates a circuit diagram for a sixth embodiment of the matching circuit according to the present disclosure. Matching circuit 2600 includes at least two inductors and at least one capacitor 2602. The at least two inductors includes a first inductor 2601a and a second inductor 2601b. The first inductor 2601a is connected in series between upstream and downstream circuits. The second inductor 2601b and capacitor 2602 are connected to each other in series, followed by a parallel connection between the upstream and downstream circuits, and are arranged at the back of the first inductor 2601a. Specifically, when used for a signal combination unit, the first inductor 2601a is connected in series to an input of the signal combination unit, and the second inductor 2601b and capacitor 2602 are connected to each other in series, followed by a parallel connection to an input of the signal combination unit and arranged at the back of the first inductor 2601a. When used for the signal separation unit, the first inductor 2601a is connected in series to an output of the signal separation unit, and the second inductor 2601b and capacitor 2602 are connected to each other in series, followed by a parallel connection to the output of the signal separation unit and arranged at the back of the first inductor 2601a.

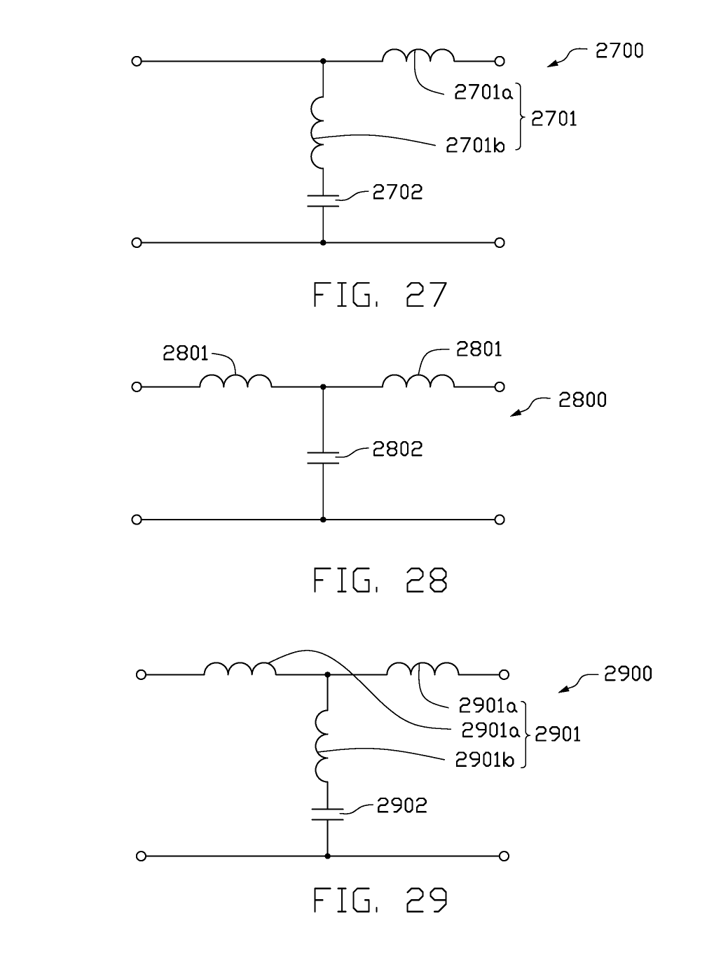

FIG. 27 schematically illustrates a circuit diagram for a seventh embodiment of the matching circuit according to the present disclosure. Matching circuit 2700 includes at least two inductors and at least one capacitor 2702. The at least two inductors includes a first inductor 2701a and a second inductor 2701b. The first inductor 2701a is connected in series between upstream and downstream circuits. The second inductor 2701b and capacitor 2702 are connected to each other in series, followed by a parallel connection between the upstream and downstream circuits, and are arranged at the front of the first inductor 2701a. Specifically, the first inductor 2701a is connected in series to an input of the signal combination unit, and the second inductor 2701b and capacitor 2602 are connected to each other in series, followed by a parallel connection to an input of the signal combination unit and arranged at the front of the first inductor 2701a when used for the signal combination unit. The first inductor 2701a is connected in series to an output of the signal separation unit, and the second inductor 2701b and capacitor 2702 are connected in series to each other, followed by a parallel connection to the output of the signal separation unit and arranged at the front of the first inductor 2701a when used for the signal separation unit.

FIG. 28 schematically illustrates a circuit diagram for an eighth embodiment of the matching circuit according to the present disclosure. Matching circuit 2800 includes at least two inductors 2801 and at least one capacitor 2802. The at least two inductors are connected in series between upstream and downstream circuits. Capacitor 2802 is connected in parallel between the upstream and downstream circuits and arranged between the at least two inductors. Specifically, the at least two inductors 2801 are connected in series to an input of the signal combination unit, and capacitor 2802 is connected in parallel to the input of the signal combination unit and arranged between the at least two inductors when used for the signal combination unit. The at least two inductors 2801 are connected in series to an output of the signal separation unit, and capacitor 2802 is connected in parallel to the output of the signal separation unit and arranged between the at least two inductors when used for the signal separation unit.

FIG. 29 schematically illustrates a circuit diagram for a ninth embodiment of the matching circuit according to the present disclosure. Matching circuit 2900 includes at least three inductors and at least one capacitor 2902. The at least three inductors include at least two first inductors 2901a and at least one second inductor 2901b. The first inductors 2901a are connected in series between upstream and downstream circuits. The second inductor 2901b and capacitor 2902 are connected to each other in series and connected in parallel between the upstream and downstream circuits and arranged between the at least two first inductors 2901a. Specifically, when used for a signal combination unit, the first inductors 2901a are connected in series to an input of the signal combination unit, and the second inductor 2901b and capacitor 2902 are connected in series, followed by a parallel connection to the input of the signal combination unit and arranged between the at least two first inductors 2901a. When used for a signal separation unit, the first inductors 2901a are connected in series to an output of the signal separation unit, and the second inductor 2901b and capacitor 2902 are connected in series, followed by a parallel connection to the output of the signal separation unit and arranged between the at least two first inductors 2901a.

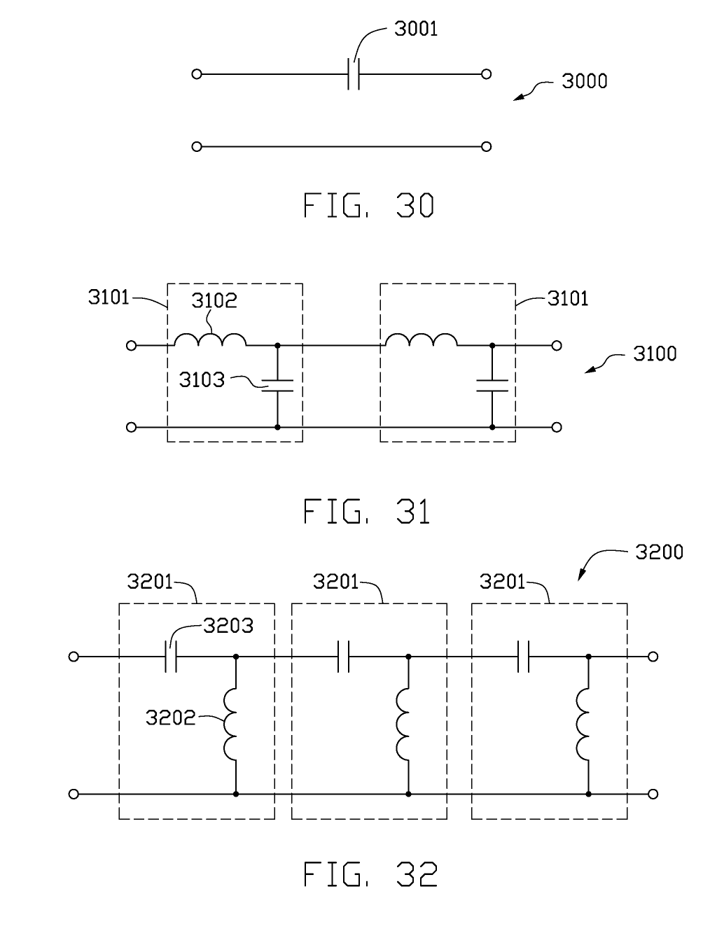

FIG. 30 schematically illustrates a circuit diagram for a tenth embodiment of the matching circuit according to the present disclosure. Matching circuit 3000 can be merely applied to a signal separation unit, which includes at least one capacitor 3001. Capacitor 3001 is connected in series between upstream and downstream circuits. Specifically, capacitor 3001 is connected in series to an output of the signal separation unit.

In the embodiments, the upstream circuit is a circuit in front of the matching circuit depending on the transmission path of the electric signal received by the antenna from the front side to back side. The downstream circuit is referred to as a circuit positioned after the matching circuit.

For filter circuits applied for signal combination unit and signal separation unit, each filter circuit can be provided with high pass filter circuit, low pass filter circuit, band pass filter circuit, band stop filter circuit, notch filter circuit and any combination thereof.

FIG. 31 schematically illustrates a circuit diagram for a first embodiment of the filter circuit according to the present disclosure. Filter circuit 3100 is a low pass filter circuit which includes at least one sub filter circuit 3101. In this embodiment, filter circuit 3100 includes two sub filter circuits 3101, each of which includes at least one inductor 3102 and at least one capacitor 3103. Inductor 3102 is connected in series between upstream and downstream circuits, and capacitor 3103 is connected in parallel between the upstream and downstream circuits and arranged at the back of inductor 3102. In other words, inductor 3102 is connected in series to an output of the upstream circuit and an input of the downstream circuit, and capacitor 3103 is connected in parallel to the output of the upstream circuit and the input of the downstream circuit and arranged at the back of inductor 3102.

FIG. 32 schematically illustrates a circuit diagram for a second embodiment of the filter circuit according to the present disclosure. Filter circuit 3200 is a high pass filer circuit which includes at least one sub filter circuit 3201. In this embodiment, filter circuit 3200 includes three sub filter circuits, each of which includes at least one inductor 3202 and at least one capacitor 3203. Capacitor 3203 is connected in series between upstream and downstream circuits, and inductor 3202 is connected in parallel between the upstream and downstream circuits and arranged at the back of capacitor 3203.

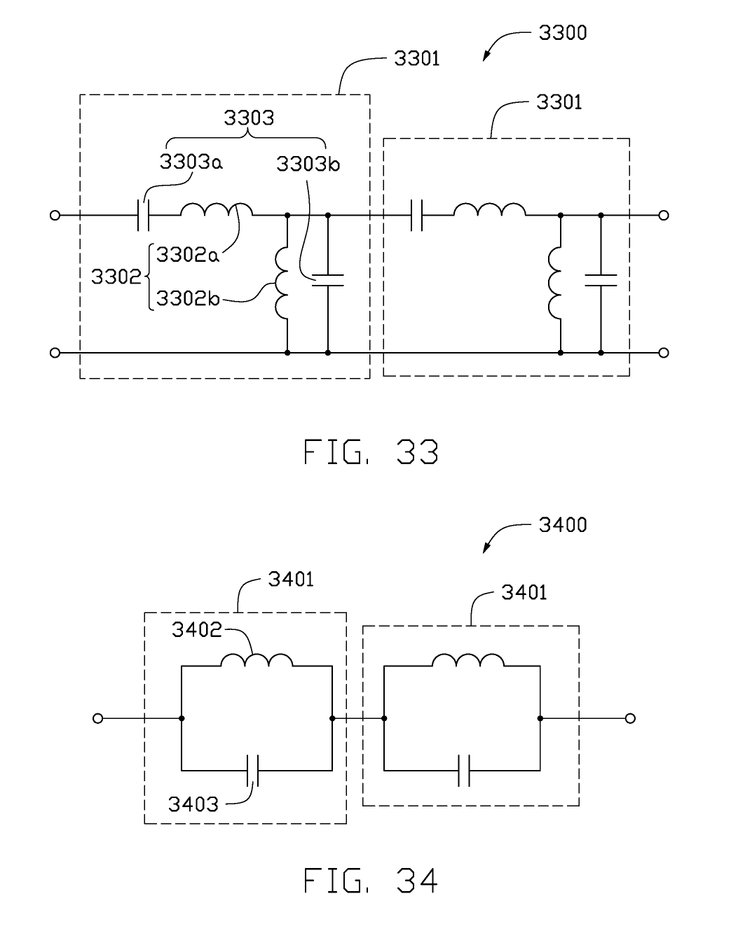

FIG. 33 schematically illustrates a circuit diagram for a third embodiment of the filter circuit according to the present disclosure. Filter circuit 3300 is a band pass filter circuit which includes at least one sub filter circuit 3301. In this embodiment, filter circuit 3300 includes two sub filter circuits, each of which includes at least two inductors 3302 and at least two capacitors 3303. At least two inductors 3302 includes at least one first inductor 3302a and at least one second inductor 3302b, and capacitor 3303 includes at least one first capacitor 3303a and at least one second capacitor 3303b. First capacitor 3303a and first inductor 3302a are connected in series between upstream and downstream circuits; second inductor 3302b and second capacitor 3303b are connected in parallel between the upstream and downstream circuits and arranged at the back of the series-connected first capacitor 3303a and first inductor 3302a. In other words, first capacitor 3303a and first inductor 3302a are connected in series to an output of the upstream circuit and to an input of the downstream circuit. Second inductor 3302b and second capacitor 3303b are connected in parallel to the output of the upstream circuit and to the input of the downstream circuit and arranged at the back of the series-connected first capacitor 3303a and first inductor 3302a.

FIG. 34 schematically illustrates a circuit diagram for a fourth embodiment of the filter circuit according to the present disclosure. Filter circuit 3400 is a band stop filter circuit, and specifically it can be a notch filter circuit which includes a least one sub filter circuit 3401. In this embodiment, filter circuit 3400 includes two sub filter circuit, each of which includes at least one inductor 3402 and at least one capacitor 3403. Inductor 3402 and capacitor 3403 are connected in parallel, followed by a series connection between upstream and downstream circuits. In other words, inductor 3402 and capacitor 3403 are connected in parallel, followed by a series connection to an output of the upstream circuit and an input of the downstream circuit.

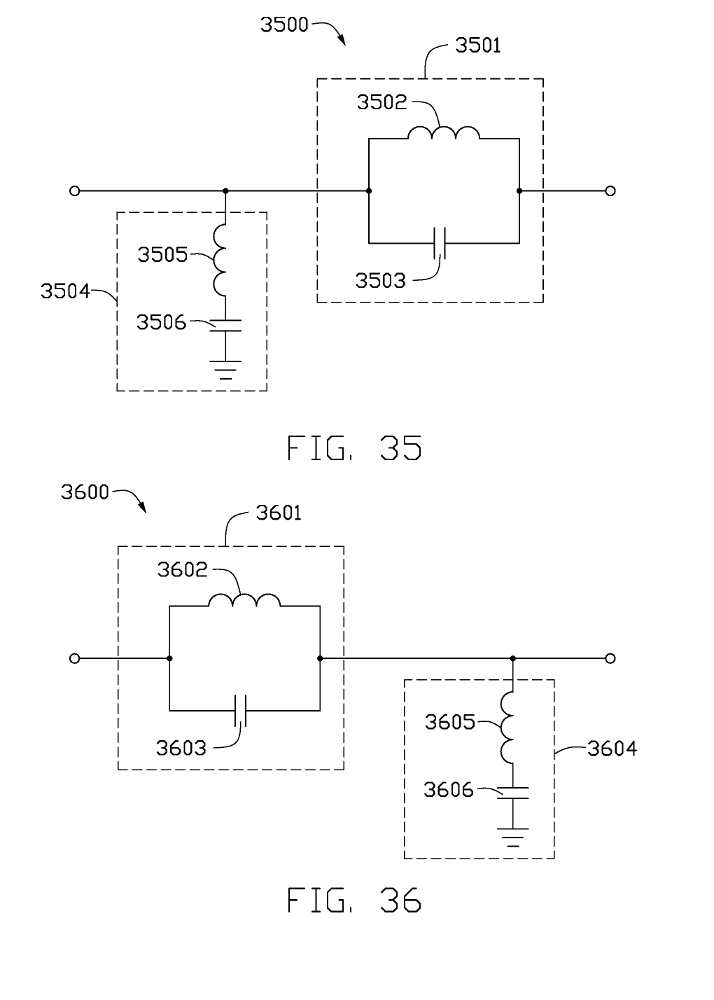

FIG. 35 schematically illustrates a circuit diagram for a fifth embodiment of the filter circuit according to the present disclosure. Filter circuit 3500 is a notch filter circuit which includes at least one sub filter circuit 3501. In this embodiment, there is one sub filter circuit which includes at least one first inductor 3502 and at least one first capacitor 3503. First inductor 3502 and first capacitor 3503 are connected in parallel, followed by a series connection between upstream and downstream circuits. Filter circuit 3500 further includes at least one ground branch circuit 3504 which is connected to the input of sub filter circuit 3501. Ground branch circuit 3504 includes at least one second inductor 3505 and at least one second capacitor 3506 that both are connected in series between the input of sub filter circuit 3501 and a ground. Filter circuit 3500 can be merely used in a signal combination unit.

FIG. 36 schematically illustrates a circuit diagram for a sixth embodiment of the filter circuit according to the present disclosure. Filter circuit 3600 is a notch filter circuit which includes at least one sub filter circuit 3601. In this embodiment, there is one sub filter circuit which includes at least one first inductor 3602 and at least one first capacitor 3603. First inductor 3602 and first capacitor 3603 are connected in parallel, followed by a series connection between upstream and downstream circuits. Filter circuit 3600 further includes at least one ground branch circuit 3604 which is connected to the output of sub filter circuit 3601. Ground branch circuit 3604 includes at least one second inductor 3605 and at least one second capacitor 3606 that both are connected in series between the output of sub filter circuit 3601 and a ground. Filter circuit 6500 can be merely used in a signal separation unit.

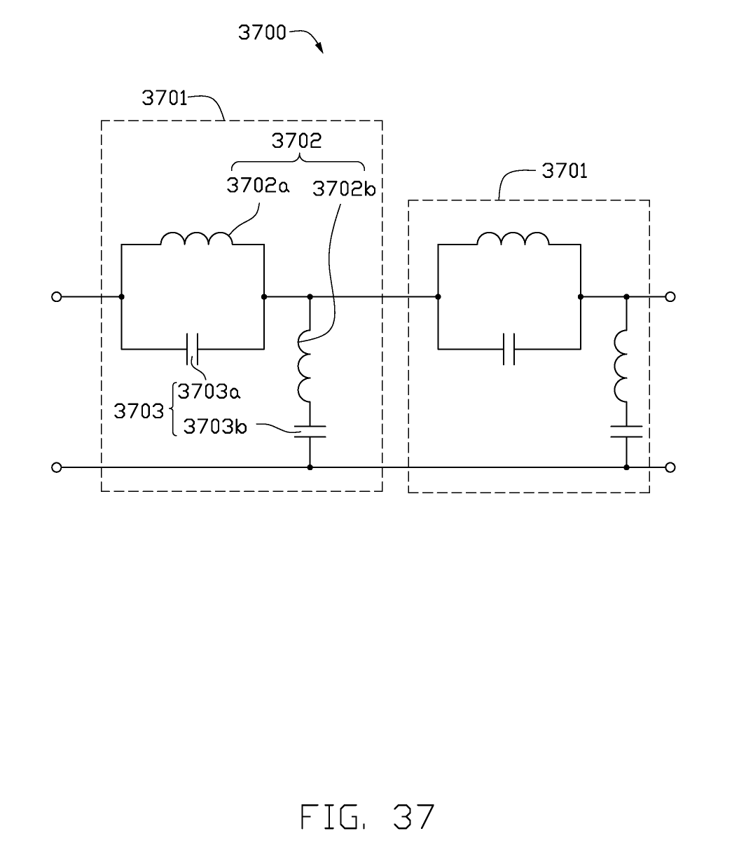

FIG. 37 schematically illustrates a circuit diagram for a seventh embodiment of the filter circuit according to the present disclosure. Filter circuit 3700 is a notch filter circuit which includes at least one sub filter circuit 3701. In this embodiment, there are two sub filter circuits, each of which includes at least two inductors 3702 and at least two capacitors 3703. At least two inductors 3702 includes at least one first inductor 3702a and at least one second inductor 3702b. At least two capacitors 3703 includes at least one first capacitor 3703a and at least one second capacitor 3703b. First inductor 3702a and first capacitor 3703a are connected in parallel, followed by a series connection between upstream and downstream circuits. Second inductor 3702b and second capacitor 3703b are connected in series, followed by a parallel connection between the upstream and downstream circuits, and are arranged at the back of the parallel-connected first inductor 3702a and first capacitor 3703a. In other words, first inductor 3702a and first capacitor 3703a are connected in parallel, followed by a series connection to an output of the upstream circuit and an input of the downstream circuit. Second inductor 3702b and second capacitor 3703b are connected in series, followed by a parallel connection to an input of the upstream circuit and an output of the downstream circuit, and are arranged at the back of the parallel-connected first inductor 3702a and first capacitor 3703a. In another embodiment, second inductor 3702b and second capacitor 3703b can be placed ahead of the parallel-connected first inductor 3702a and first capacitor 3703a.

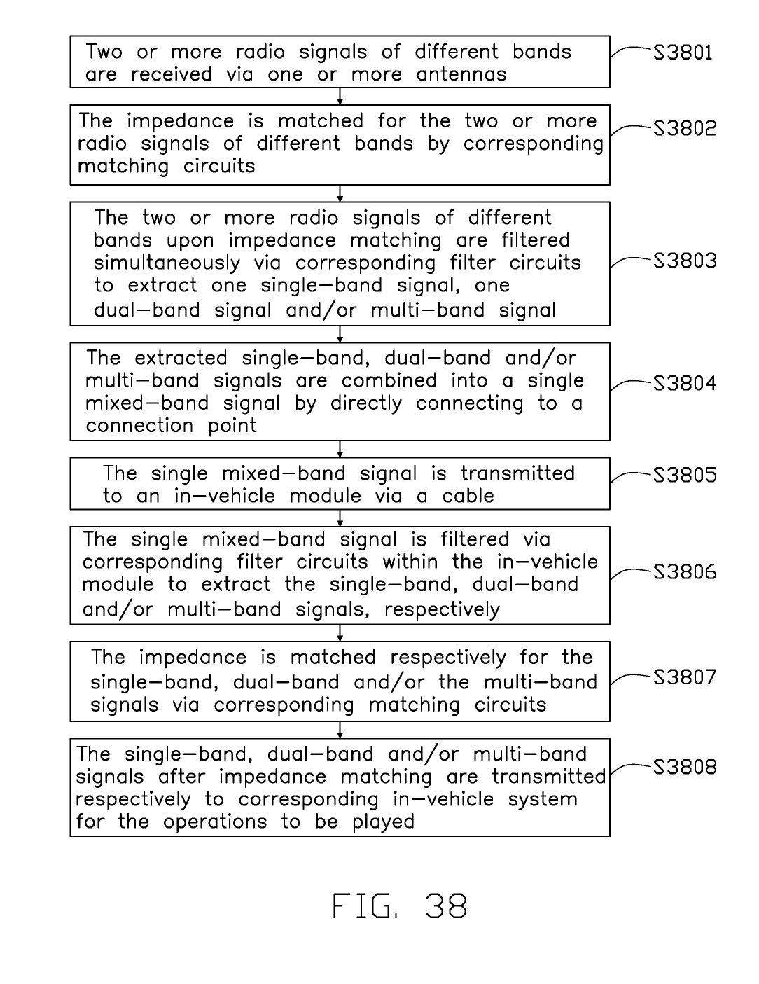

FIG. 38 is a flow chart of a first embodiment of a method for receiving multiple radio signals using vehicular receiving antenna in the present disclosure. The method applied in receiving antenna device for a vehicle comprises steps as follows.

At S3801, two or more radio signals of different bands are received via one or more antennas.

At S3802, the impedance is matched for the two or more radio signals of different bands by corresponding matching circuits.

At S3803, the two or more radio signals of different bands upon impedance matching are filtered simultaneously via corresponding filter circuits to extract one single-band signal, one dual-band signal and/or multi-band signal.

At S3804, the extracted single-band, dual-band and/or multi-band signals are combined into a single mixed-band signal by directly connecting to a connection point.

At S3805, the single mixed-band signal is transmitted to an in-vehicle module via a cable.

At S3806, the single mixed-band signal is filtered via corresponding filter circuits within the in-vehicle module to extract the single-band, dual-band and/or multi-band signals, respectively.

At S3807, the impedance is matched respectively for the single-band, dual-band and/or the multi-band signals via corresponding matching circuits.

At S3808, the single-band, dual-band and/or multi-band signals after impedance matching are transmitted respectively to corresponding in-vehicle system for the operations to be played.

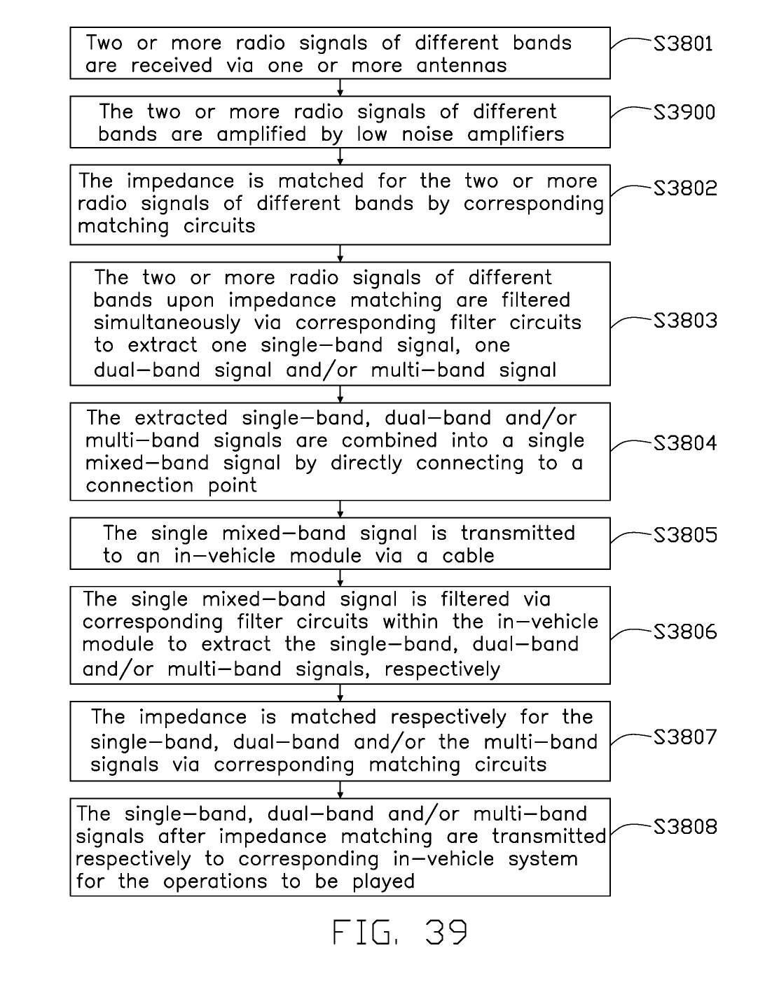

FIG. 39 shows a second embodiment of a method for receiving multiple radio signals using vehicular receiving antenna in the present disclosure, which further comprises step S3900 to amplify the two or more radio signals of different bands by low noise amplifiers.

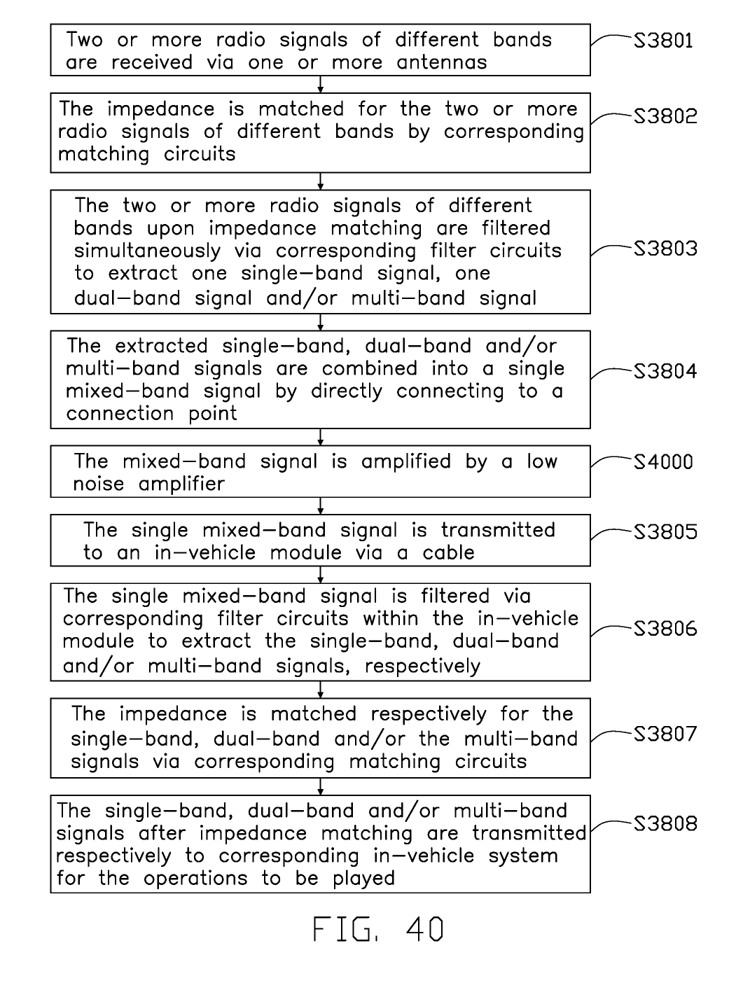

FIG. 40 shows a third embodiment of a method for receiving multiple radio signals using vehicular receiving antenna in the present disclosure, which further comprises step S4000 to amplify the mixed-band signal by a low noise amplifier.

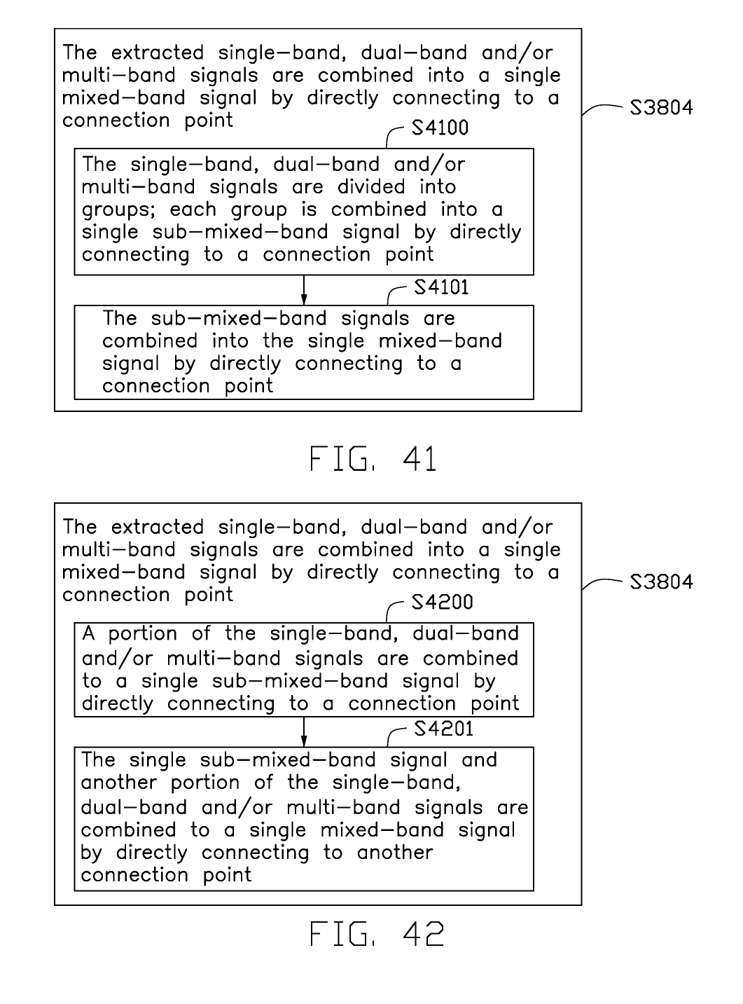

FIG. 41 shows a fourth embodiment of a method for receiving multiple radio signals using vehicular receiving antenna in the present disclosure. The step S3804 further comprises sub steps S4100 and S4101. At sub step S4100, the single-band, dual-band and/or multi-band signals are divided into groups; each group is combined into a single sub-mixed-band signal by directly connecting to a connection point. At sub step S4101, the sub-mixed-band signals are combined into the single mixed-band signal by directly connecting to a connection point.

FIG. 42 shows a fifth embodiment of a method for receiving multiple radio signals using vehicular receiving antenna in the present disclosure. The step S3804 further comprises sub step S4200 and sub step 4201. At sub step S4200, a portion of the single-band, dual-band and/or multi-band signals are combined to a single sub-mixed-band signal by directly connecting to a connection point. At sub step 4201, the single sub-mixed-band signal and another portion of the single-band, dual-band and/or multi-band signals are combined to a single mixed-band signal by directly connecting to another connection point.

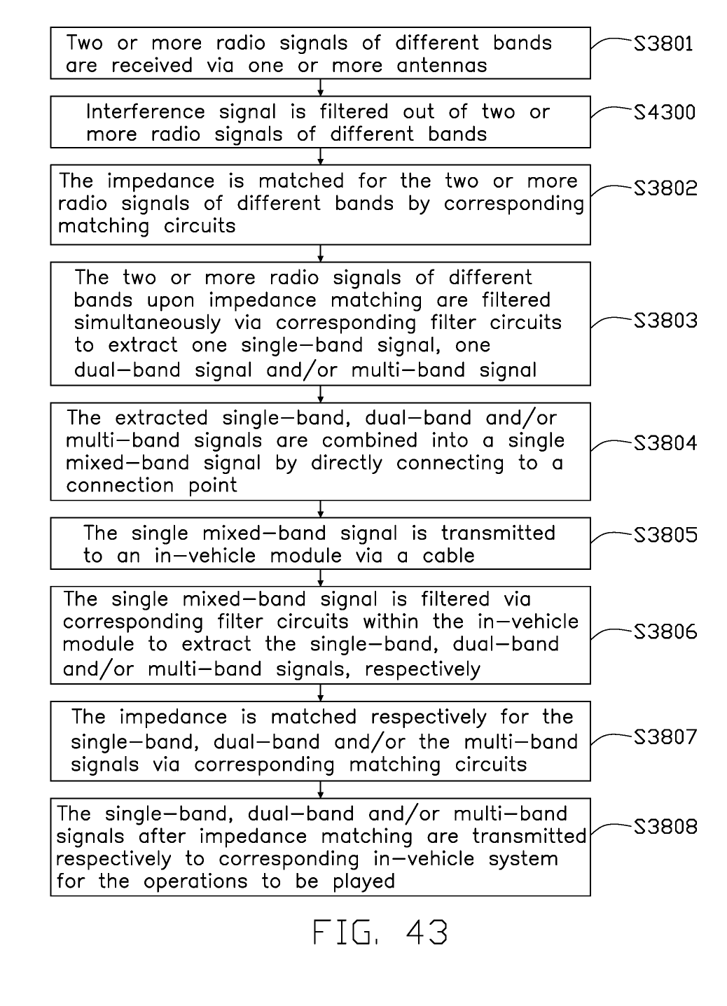

FIG. 43 shows a sixth embodiment of a method for receiving multiple radio signals using vehicular receiving antenna in the present disclosure, which further comprises step S4300 to filter out interference signal of two or more radio signals of different bands.

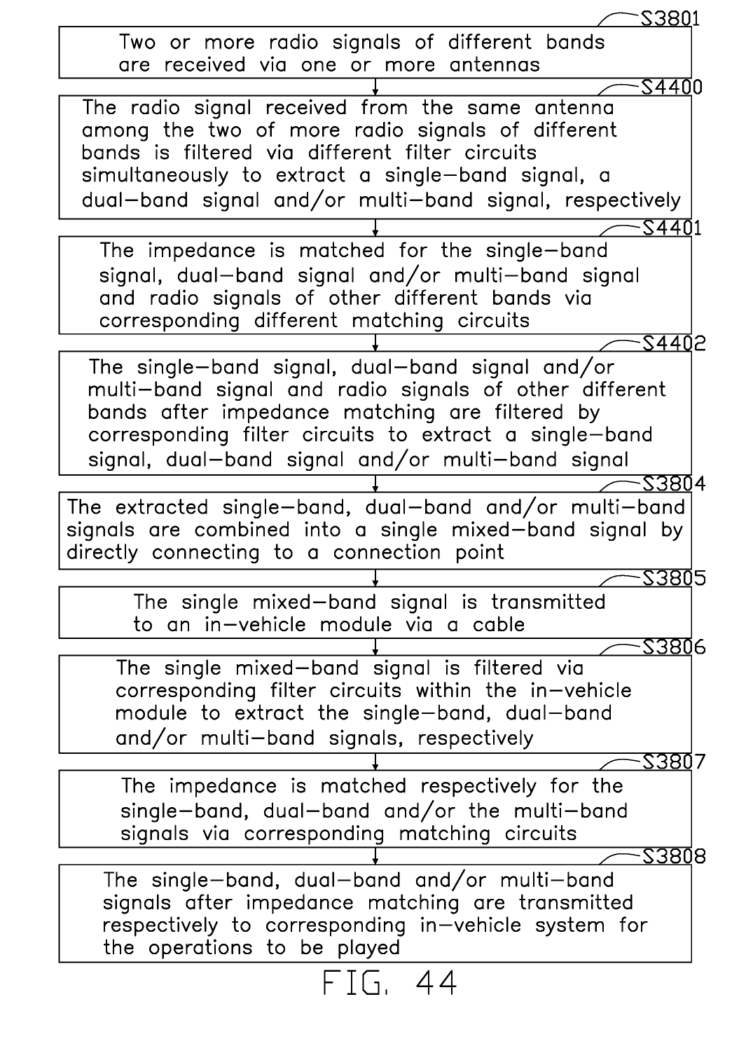

FIG. 44 shows a seventh embodiment of a method for receiving multiple radio signals using vehicular receiving antenna in the present disclosure, which further comprises step S4400, after step S3801, in which the radio signal received from the same antenna among the two of more radio signals of different bands is filtered via different filter circuits simultaneously to extract a single-band signal, a dual-band signal and/or multi-band signal, respectively. In addition, step 3802 of the first embodiment is replaced by step S4401 in which the impedance is matched for the single-band signal, dual-band signal and/or multi-band signal and radio signals of other different bands via corresponding different matching circuits. Step 3803 of the first embodiment is replaced by step 4402 in which the single-band signal, dual-band signal and/or multi-band signal and radio signals of other different bands after impedance matching are filtered by corresponding filter circuits to extract a single-band signal, dual-band signal and/or multi-band signal.

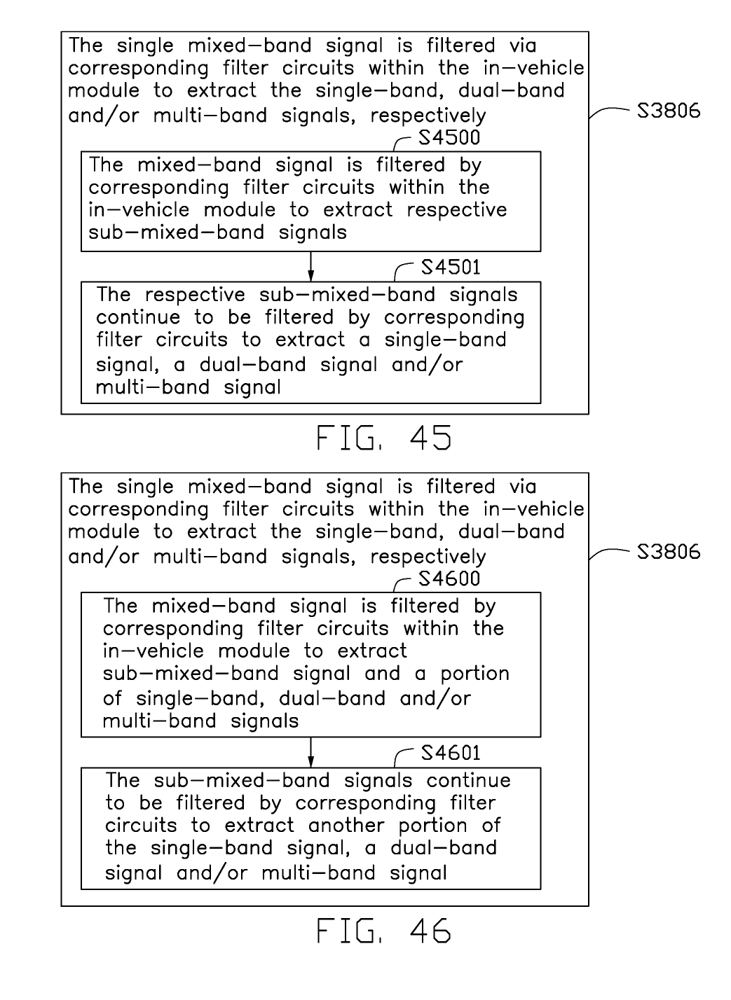

FIG. 45 shows an eighth embodiment of a method for receiving multiple radio signals using vehicular receiving antenna in the present disclosure. The step S3806 further comprises sub step S4500 and sub step 4501. At sub step S4500, the mixed-band signal is filtered by corresponding filter circuits within the in-vehicle module to extract respective sub-mixed-band signals. At sub step 4501, the respective sub-mixed-band signals continue to be filtered by corresponding filter circuits to extract a single-band signal, a dual-band signal and/or multi-band signal.

FIG. 46 shows an eighth embodiment of a method for receiving multiple radio signals using vehicular receiving antenna in the present disclosure. The step S3806 further comprises sub step S4600 and sub step 4601. At sub step S4600, the mixed-band signal is filtered by corresponding filter circuits within the in-vehicle module to extract sub-mixed-band signal and a portion of single-band, dual-band and/or multi-band signals. At sub step 4601, the sub-mixed-band signals continue to be filtered by corresponding filter circuits to extract another portion of the single-band signal, a dual-band signal and/or multi-band signal.

Previous descriptions are only embodiments of the present disclosure and are not intended to limit the scope of the present disclosure. Many variations and modifications according to the claims and specification of the disclosure are still within the scope of the claimed disclosure. In addition, each of the embodiments and claims does not have to achieve all the advantages or characteristics disclosed. Moreover, the abstract and the title only serve to facilitate searching patent documents and are not intended in any way to limit the scope of the claimed disclosure.

It will be apparent to those skilled that the present disclosure is not limited to the details of the foregoing exemplary embodiments, and that the disclosure may be realized in any other specific forms without departing from the spirit or essential characteristics of the present disclosure. Therefore, all the aforementioned embodiments should only be considered as illustrative and not restrictive in all aspects. The scope of the disclosure is defined by the claims rather than by the foregoing descriptions, and therefore the scope of the disclosure is intended to cover any changes within equivalent meaning and range thereof. Any numbering in the claims shall not be construed as limiting the claims. Furthermore, “comprise” does not exclude other elements or steps, and the singular does not exclude a plurality. The plurality of units or means recited in the system claims may also be realized by software or hardware from a unit or device.

What is claimed is:

1. A receiving antenna device for a vehicle, comprising:
an in-vehicle module, coupled to an in-vehicle system and comprising at least one signal separation unit; and
a receiving antenna module, coupled to the in-vehicle module via a single cable and comprising:
at least one antenna;
at least one low noise amplifier (LNA); and
at least one signal combination unit;
wherein the at least one signal combination unit is configured to combine at least two radio signals of different bands received by the antenna into a single mixed-band signal, the signal combination unit comprises at least two input terminals, one output terminal and at least two branch circuits, each of the branch circuits is coupled between one of the two input terminals and the output terminal and comprises at least one filter circuit configured to filter one of the at least two radio signals of different bands to extract a single-band signal, two of the single-band signal extracted from the branch circuits of the signal combination unit are combined into the single mixed-band signal;
the at least one signal separation unit is configured to split the single mixed-band signal into at least two of single-band signals, dual-band signals, multi-band signals or a combination thereof and transmit the split signals to the in-vehicle module, the signal separation unit comprises one of the input terminals, at least two of the output terminal and at least two of the branch circuits, each of the branch circuits is coupled between the input terminal and one of the two output terminals and comprises at least one filter circuit configured to filter the single mixed-band signal to extract one of the single-band signals, the dual-band signals or the multi-band signals.

2. The receiving antenna device of claim 1, wherein the filter circuit of the signal combination unit comprises at least one of a low pass filter circuit, a high pass filter circuit, a band pass filter circuit, a band stop filter circuit and a notch filter circuit.

3. The receiving antenna device of claim 1, wherein the filter circuit of the signal separation unit comprises at least one of a low pass filter circuit, a high pass filter circuit, a band pass filter circuit, a band stop filter circuit and a notch filter circuit.

4. The receiving antenna device of claim 1, wherein each of the branch circuits of the signal combination unit further comprises a matching circuit at a front of the filter circuit, and the matching circuit is configured to match an impedance of an antennas and an impedance of the filter circuit.

5. The receiving antenna device of claim 1, wherein each of the branch circuits of the signal separation unit further comprises a matching circuit at a back of the filter circuit, and the matching circuit is configured to match an impedance of the in-vehicle system and an impedance of the filter circuit.

6. The receiving antenna device of claim 1, wherein the receiving antenna module further comprises a pre-filter configured to filter out at least a part of an interference signal received by the antenna and coupled between the antenna and the LNA or between two of the LNA.

7. The receiving antenna device of claim 1, wherein the LNA is coupled to at least one of an input of the signal combination unit and an output of the signal combination unit.

8. The receiving antenna device of claim 1, wherein the receiving antenna module comprises a plurality of the antenna and two of the signal combination unit, the two signal combination units comprises a pre-stage signal combination unit and a post-stage signal combination unit, a part of the antennas are coupled to the pre-stage signal combination unit for combining at least two of the radio signals of different bands received by the part of the antennas into a sub-mixed-band signal, and the post-stage signal combination unit is configured to combine the sub-mixed-band signal outputted by the pre-stage signal combination unit and the radio signals received by another part of the antennas into the single mixed-band signal.

9. The receiving antenna device of claim 1, wherein the receiving antenna module comprises a plurality of the antenna and a plurality of the signal combination unit, the signal combination units comprises at least two pre-stage signal combination units and at least one post-stage signal combination unit, a part of the antennas are coupled to one of the pre-stage signal combination units for combining at least two of the radio signals of different bands received by the part of the antennas into a sub-mixed-band signal, and the post-stage signal combination unit is configured to combine a plurality of the sub-mixed-band signal outputted from the pre-stage signal combination units into the single mixed-band signal.

10. The receiving antenna device of claim 1, wherein the antenna is at least one of a dual-band antenna for receiving the dual-band signal and a multi-band antenna for receiving the multi-band signal.

11. The receiving antenna device of claim 10, wherein the receiving antenna module further comprises at least one of additional signal separation unit coupled between the antenna and the LNA for splitting the dual-band signal from the dual-band antenna or the multi-band signal from the multi-band antenna into two or more of single-band signals, dual-band signals and the multi-band signals.

12. The receiving antenna device of claim 10, wherein the signal separation unit is made of a high pass filter, a low pass filter or a notch filter.

13. The receiving antenna device of claim 1, wherein the in-vehicle module comprises two of the signal separation unit, the two signal separation units comprise a pre-stage signal separation unit and a post-stage signal separation unit, the pre-stage signal separation unit is configured to split the single mixed-band signal into a sub-mixed-band signal and radio signals of different bands, and the post-stage signal separation unit is configured to split the sub-mixed-band signal outputted by the pre-stage signal separation unit into at least two of single-band signals, dual-band signals and multi-band signals or a combination thereof.

14. The receiving antenna device of claim 1, wherein the in-vehicle module includes a plurality of the signal separation unit, the plurality of signal separation unit comprise a pre-stage signal separation unit and at least two post-stage signal separation units, the pre-stage signal separation unit is configured to split the single mixed-band signal into at least two of sub-mixed-band signals, and each of the post-stage signal separation units is configured to split one of the sub-mixed-band signals into at least two of single-band signals, dual-band signals and multi-band signals or a combination thereof.

15. A system for receiving radio signals for a vehicle, comprising a casing, an installation base and a receiving antenna device as claimed in claim 1 wherein the receiving antenna module is installed on the installation base and positioned in a space formed between the casing and the installation base.

16. A method of receiving radio signal for a vehicle, comprising steps of:
receiving two or more radio signals of different bands from at least one antenna;
matching an impedance for the two or more radio signals of different bands by matching circuits corresponding to the radio signals of different bands;
filtering the two or more radio signals of different bands with the matched impedance by filter circuits corresponding to the radio signals of different bands to extract at least one of a single-band signal, a dual-band signal and a multi-band signal;
combining at least two of the single-band signal, the dual-band signal and the multi-band signal into a single mixed-band signal by directing the signals to a connection point;
transmitting the single mixed-band signal to an in-vehicle module via a single cable;
filtering the single mixed-band signal through a filter circuit of the in-vehicle module to extract the at least one of the single-band signal, the dual-band signal and the multi-band signal; and
matching an impedance for at least one of the extracted single-band signal, the extracted dual-band signal and the extracted multi-band signal by matching circuits of the in-vehicle module.

17. The method of claim 16, further comprising a step of amplifying the single mixed-band signal by a low noise amplifier (LNA), a step of amplifying the two or more radio signals of different bands by the low noise amplifier (LNA), or a step of amplifying the single mixed-band signal and the two or more radio signals of different bands by the low noise amplifier (LNA).

18. The method of claim 16, wherein the step of combining at least two of the single-band signal, the dual-band signal and the multi-band signal into a single mixed-band signal by directing the signals to a connection point further comprises steps of:
dividing the at least one of the single-band signal, the dual-band signal and the multi-band signal into groups and combining signals of each of the groups into a sub-mixed-band signal by directing the signals of each of the groups to a connection point; and
combining at least two of the sub-mixed-band signal from each of the groups into the single mixed-band signal by directing the at least two of sub-mixed-band signal to another connection point.

19. The method of claim 16, wherein the step of combining at least two of the single-band signal, the dual-band signal and the multi-band signal into a single mixed-band signal by directing the signals to a connection point further comprises steps of:
combining a part of the at least two of the single-band signal, the dual-band signal and the multi-band signal into a sub-mixed-band signal by directing the part of the signals to a connection point; and
combining the sub-mixed-band signal and another part of the at least two of the single-band signal, the dual-band signal and the multi-band signal into the single mixed-band signal by directing the sub-mixed-band signal and the another part of the signals to another connection point.

20. The method of claim 16, further comprising a step of: filtering out at least a part of an interference signal of the two or more radio signals of different bands.
